(19) United States
(12) Patent Application Publication
(10) Pub. No.: US 2010/0162068 A1
(43) Pub. Date: Jun. 24, 2010

(54) MEMORY DEVICE

(75) Inventor: Haruki TODA, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/607,432

(22) Filed: Oct. 28, 2009

(30) Foreign Application Priority Data
Dec. 19, 2008 (JP) 2008-323524

(51) Int. Cl. G06F 11/07

(52) U.S. Cl. 714/747; 714/E11.023

(57) ABSTRACT

A memory device including: a memory cell array; an error-detecting and correcting circuit; and a buffer register disposed for temporally storing write and read data. Write data loaded in the buffer register are encoded in the error-detecting and correcting circuit to be over-written in the buffer register together with check bits, and then transferred to be written into the cell array. Read data read from the cell array and held in the buffer register together with check bits are decoded in the error-detecting and correcting circuit to be corrected, over-written in the buffer register and then output.

### CROSS-REFERENCE TO RELATED APPLICATION

This application is based on and claims the benefit of priority from the prior Japanese Patent Application No. 2008-323524, filed on Dec. 19, 2008, the entire contents of which are incorporated herein by reference.

### BACKGROUND OF THE INVENTION

1. Field of the Invention

This invention relates to a memory device with an error-detecting and correcting circuit installed therein.

2. Description of the Related Arts

In a memory device with a large capacity such as a resistance change RAM (ReRAM), the stored contents are often destroyed due to various causes while being stored. Specifically in case the physical mechanism used for storing a resistance state as data is easily influenced by external disturbances, as the memory capacity is increased and the cell size is shrunk more, the error rate will be increased more. Therefore, it matters to install an on-chip error-detecting and correcting circuit in the memory device.

For example, error correction of 2-bit or more may be performed in an ECC system with BCH code (i.e., BCH-ECC system) constituted on Galois field GF(2ⁿ). In the ECC system, if such a method is used for solving the error searching equation that elements of the finite field are substituted one by one, the operation time becomes very long, and the read and write performance will be greatly reduced even if the ECC system is installed. Therefore, it is desired to form an ECC system without one by one searching described above, and without sacrificing the memory performance.

An ReRAM is suitable not only for shrinking the cell size but also for constituting a cross-point cell array, and it is also easy to stack the cross-point cell arrays. Therefore, it is noticed for succeeding the conventional NAND type flash memory to constitute a file memory with a large capacity. However, the resistance change element used in the ReRAM cell is not stabilized while a high voltage is not applied to it. Therefore, it is in need of contriving to achieve high speed data transfer while keeping a high reliability.

There has been proposed a technology of installing an ECC circuit in a memory chip or memory controller thereof, for example, in JP 2000-173289A. Further, there has already been proposed a technology of refreshing data bits and check bits with respect to an ECC circuit in JP-2006-527447A.

### SUMMARY OF THE INVENTION

According to an aspect of the present invention, there is provided a memory device including:

a memory cell array;

an error-detecting and correcting circuit configured to detect and correct errors contained in read data read from the memory cell array; and

a buffer register disposed for temporally storing write data to be written into the memory cell array and read data read from the memory cell array, wherein

write data loaded in the buffer register are encoded in the error-detecting and correcting circuit to be over-written in the buffer register together with check bits, and then transferred to and written into the memory cell array, and

read data read from the memory cell array and held in the buffer register together with check bits are decoded in the error-detecting and correcting circuit to be corrected, over-written in the buffer register and then output to the external.

According to another aspect of the present invention, there is provided a memory device including:

a memory cell array;

an error-detecting and correcting circuit configured to detect and correct errors contained in read data read from the memory cell array; and

two systems of buffer registers disposed for temporally storing write or read data, wherein

the memory device has an external data transfer mode, in which read or write data are alternately burst-transferred with the two systems of the buffer registers, and wherein

within a burst cycle in one of the buffer registers, an internal data transfer mode including write data transfer and read data transfer is performed between the other buffer register and the memory cell array.

### BRIEF DESCRIPTION OF THE DRAWINGS

FIG. 1 shows a configuration of a cell array block and the underlying control circuit in accordance with an embodiment of the present invention.

FIG. 2 shows the equivalent circuit of the cell array block.

FIG. 3 shows a sense system of the memory.

FIG. 4 shows a current sensing type of a sense amplifier.

FIG. 5 shows the operation waveforms for the sense amplifier.

FIG. 6 shows a write control circuit of the memory.

FIG. 7 shows the signal levels in the write control circuit.

FIG. 8 shows a relationship between 4 Mb cell array block, sense amplifier circuit and data buses.

FIG. 9 shows a block indication of 4 MB×4.

FIG. 10 shows a cell array unit indication of 68 Mb/mat.

FIG. 11 shows file memory example 1 of (8 Gb+832 Mb)×m.

FIG. 12 shows file memory example 2 of (8 Gb+832 Mb)×m.

FIG. 13 shows a block configuration of the examples 1 and 2.

FIG. 14 shows encode part ENC of the ECC circuit.

FIG. 15 shows the decode part DEC of the ECC circuit.

FIG. 16 is a diagram for explaining the write data transfer operation in case of ×8IO.

FIG. 17 is a diagram for explaining the write data transfer operation in case of ×16IO.

FIG. 18 is a diagram for explaining the read data transfer operation in case of ×8IO.

FIG. 19 is a diagram for explaining the read data transfer operation in case of ×16IO.

FIG. 20 is a diagram for explaining the external data transfer and internal data transfer with two systems of buffer registers.

FIG. 21 is a diagram for explaining an interleave operation of the burst data transfer.

FIG. 22 shows a timing specification of the burst data transfer.

FIG. 23 is a diagram for explaining an interrupt operation in the burst cycle.

FIG. 24 is a diagram for explaining a stop operation for forcedly finishing the burst cycle.

FIG. 25 shows an example of write data transfer without passing ECC circuit performed after the read burst.

FIG. 26 shows another example of write data transfer with passing ECC circuit performed after the write burst.

FIG. 27 is a diagram for explaining the timing specification of the interrupt processing in the burst cycle.

FIG. 28 shows an interleave operation of the burst cycles with two systems of buffer registers.

FIG. 29 shows an example, in which a refresh burst cycle is set in the burst transfer sequence.

FIG. 30 shows an example, in which a mask write cycle is set in the burst transfer sequence.

FIG. 31 shows an example, in which a repeat write cycle is set in the burst transfer sequence.

FIG. 32 shows an example, in which a repeat read cycle is set in the burst transfer sequence.

FIG. 33 is a diagram for explaining a timing specification of command and burst address taking.

FIG. 34 shows an example of command data bit setting.

### DETAILED DESCRIPTION OF THE EMBODIMENTS

Illustrative embodiments of this invention will be explained with reference to the accompanying drawings below.

In the embodiment, it will be explained a memory system, which performs a high speed data transfer operation while keeping the data reliability in spite of that data errors are generated due to the resistance change material. Further, it will be shown in the embodiment that a file memory with a large capacity is achieved, and high-speed data transferring timing and sequence are defined therein.

The technical elements in the embodiment will be summarized as follows:

(1) The memory system includes a buffer register for performing data read and write under the clock synchronization control, and an ECC circuit. The number of data bits in the buffer register is set to be integer times data bits including check bits used in an error-detecting and correcting process in the ECC circuit.

(2) When reading data, read data read in parallel from the cell array are decoded in the ECC circuit, and stored in the buffer register as corrected read data, which will be output to the external as burst-transferred data.

(3) When writing data, write data supplied from the external are burst-transferred to and loaded in the buffer register, and encoded in the ECC circuit to be over-written into the buffer register as error-correctable code data, which are transferred to and written into the memory cell array.

(4) “Internal data transfer” performed between the memory cell array and the buffer register via the ECC circuit and “external data transfer” performed between the buffer register and the external terminals are alternately repeated. Without relation to data read mode and data write mode, the buffer register will be stored with data by use of the internal data transfer previous to the external data transfer.

(5) There are prepared two systems of buffer registers, with which “external data transfer” is performed as burst data transfer defined by an interleave operation. While the external data transfer defined by burst-transfer is performed in one of the buffer registers, “internal data transfer” is performed in the other buffer register.

(6) An ECC refresh mode is set for refreshing the cell array data, which is defined as to write back the read data into the cell array. The read data stored in the buffer register read from the cell array is passed through the ECC circuit to be error-corrected. Rewriting this error-corrected read data into the cell array without passing through the ECC circuit, data will be refreshed.

(7) When the burst transfer (i.e., external data transfer between the buffer register and the external) is interrupted, a new burst sequence starts under the transfer control in accordance with a status signal showing the internal data transfer state.

(8) The above-described ECC refresh will be performed in correspondence with the number of the internal data transfer operations.

(9) A memory cell array is constructed as a three-dimensional cell array, in which multiple cell array mats each having a resistance change type of memory cells arranged. The external data transfer via the buffer register is performed as a chain of clock bursts. To control this data transfer, various control signals such as command, address, operation mode designating signals, burst data and the head address designating signals and layer address designating signals will be interfaced.

The detailed embodiment will be explained below.

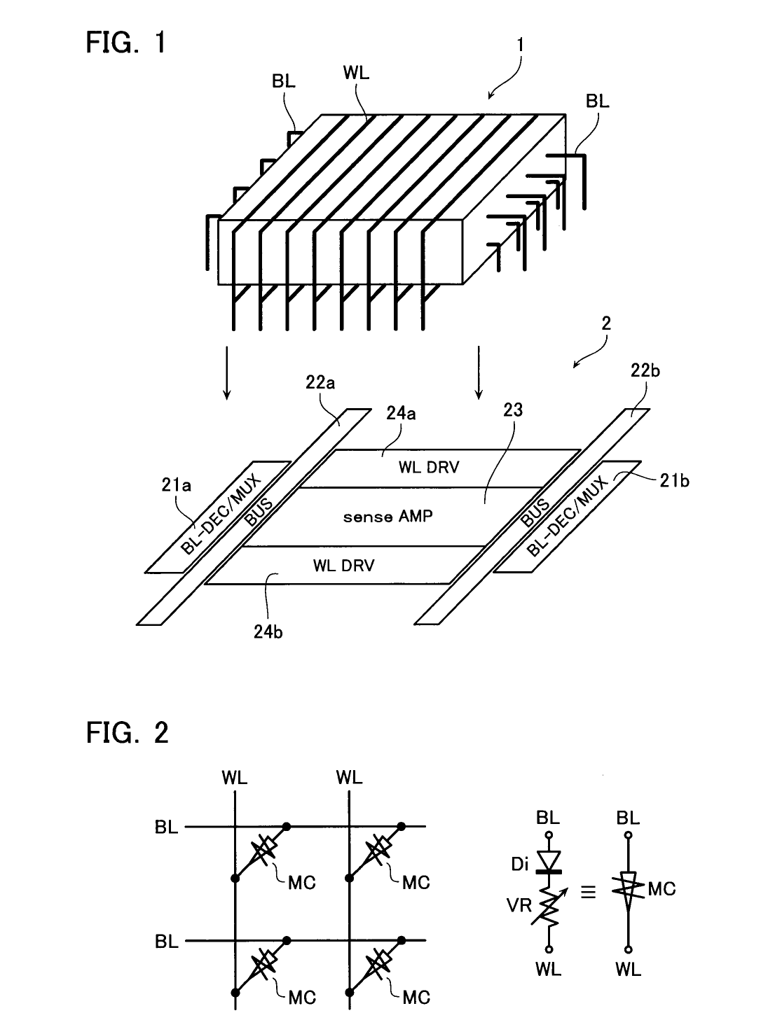

FIG. 1 shows a three-dimensional (3D) cell array block 1 with memory cells arranged three-dimensionally and a control circuit 2 formed on a semiconductor substrate underlying the cell array block 1. Word lines WL and bit lines BL serving as select lines in the cell array block 1 go through vertical wiring areas disposed at the four sides of the cell array block 1 to be coupled to the control circuit 2.

A practical file memory is formed by arranging multiple cell array blocks described above in a matrix manner. The details of the file memory will be explained later.

FIG. 2 shows an equivalent circuit of a unit layer (i.e., mat) of the cell array block 1. Word lines WL and bit lines BL are arranged to cross each other, and memory cells MC of a resistance change type are disposed at the respective cross points. A memory cell MC is formed of a variable resistance element VR and a diode Di connected in series. Here is shown that the signal lines on the anode side are defined as bit lines BL while the signal lines on the cathode side are defined as word lines WL.

Control circuit 2 has bit line decoder/multiplexer circuits 21a and 21b disposed to correspond to the both ends of the bit lines BL. That is, bit lines BL derived at the both sides of the cell array block 1 to be connected with the substrate, and selected in these decoder/multiplexer circuits 21a and 21b with command and address signals supplied from the external to be applied with voltages, and then coupled to the sense amplifier circuit 23 via buses 22a and 22b.

In a read mode, as described later, a current-sensing type of sense amplifier compares cell current with a reference current to sense data. In a write mode, sense amplifier circuit 23 and decoder/multiplexer circuits 21a and 21b supplies a predetermined write voltage or write current to a selected cell.

Disposed at the both ends in the word line direction on the substrate are word line decoder/drivers 24a and 24b, to which word lines WL are coupled in accordance with command and address, so that word lines WL are applied with suitable levels.

Bus areas 22a and 22b, which are used for reciprocating data between the external and the cell array, are disposed on the gap areas set between cell array block 1 and decoder/multiplexer circuits 21a and 21b. Therefore, bit lines BL are passed over the bus areas 22a and 22b to be coupled to the decoder/multiplexer circuits 21a and 21b.

Bit line signals are transferred to the sense amplifier circuit 23 via bus areas 22a and 22b to be sensed and amplified in a read mode, and transformed to write voltage/current in accordance with write data in a write mode. Sense amplifier circuit 23 reciprocates data between the cell array block and the external via the bus areas 22a and 22b.

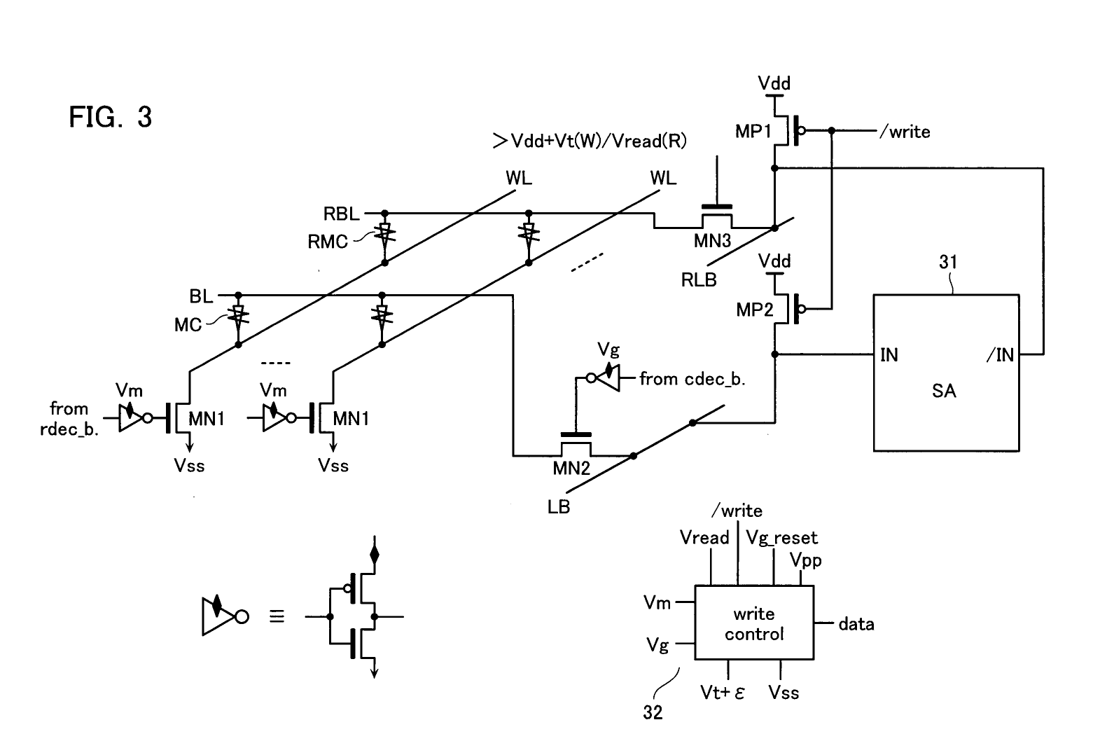

FIG. 3 shows a detailed configuration of a sense system in relation to the word lines WL and bit lines BL in a mat.

A specified bit line in a mat is fixed as a reference bit line RBL, and memory cells coupled to this reference bit line RBL are set as reference cells RMC. There is shown only one reference bit line RBL in FIG. 3. However, multiple reference bit lines RBL are prepared in general in such a manner that each reference bit line RBL is shared by multiple bit lines BL, and a bit line BL and a reference bit line RBL are selected simultaneously to constitute a pair. This sense system is closed in each mat.

Reference cells RMC coupled to reference bit line RBL are set in a “set state” (i.e., in a low resistance state), which is a cell state after forming. After selected as reference bit line, reference cell RMC is not set in other states (for example, reset state) excepting the set state. That is, when a memory cell MC is to be written, bit line BL and reference bit line RBL are simultaneously selected on a word line WL, the reference cell RMC on the reference bit line RBL is written into the set state.

In other words, the reference cell RMC on the reference bit line RBL is always written into the set state in a write mode. Therefore, the reference cell RMC is refreshed in the write mode to be a stabilized set state serving as a reference level used in a read mode.

In the successive explanations, the set state defined by a low resistance value is referred to as data “1”; and the reset state defined by a high resistance value as data “0”.

Cell current of memory cell MC flowing on the bit line BL and reference current of reference cell RMC flowing on the reference bit line RBL are input to two input nodes, IN and /IN, of the sense amplifier(SA) 31 via local buses LB and RLB, respectively. As described later, the practical reference current is reduced to about one tenth with a current mirror circuit when it is input to the sense amplifier.

The circuit operation in FIG. 3 will be explained in detail as follows. When word line WL is selected, word line switch transistor MN1 is driven by decoded signal “from rdec_b.” from the row decoder to be turned on, and word line WL is set at Vss. On the other hand, when bit line BL and reference bit line RBL are selected, bit line switch transistors MN2 and MN3 are driven by column decoder output and reference column decoder output to be turned on, and the bit line BL and reference bit line RBL are coupled to local buses LB and RLB, which are coupled to the input nodes IN and /IN of the sense amplifier(SA) 31, respectively.

Word line selecting transistor MN1 is selected by a “L” level signal output from the row decoder, and on-resistance of it is controlled by the gate level Vm. This gate level Vm will be exchanged in correspondence with operation modes such as forming, “1” write, “0” write and read operations. Bit line selecting transistor MN2 is selected by a “L” level signal output from the column decoder, and on resistance of it is controlled by the gate level Vg. This gate level Vg will be exchanged in correspondence with operation modes such as forming, “1” write, “0” write and read operations.

Selecting transistor MN3 of the reference bit line RBL is selected by a gate level equal to or higher than Vdd+Vt in a write mode, and another gate level Vread in a read mode. Vt is a threshold voltage of an NMOS transistor.

As shown in FIG. 3, there is prepared a write control circuit 32 as a level generating circuit for generating the control voltages Vm and Vg of the above-described selecting transistors. The details will be explained later.

PMOS transistors MP1 and MP2 coupled to the local buses RLB, LB are selected by select signal “/write” (=“L”) in a write mode, so that the local buses RLB and LB are set at the power supply voltage Vdd.

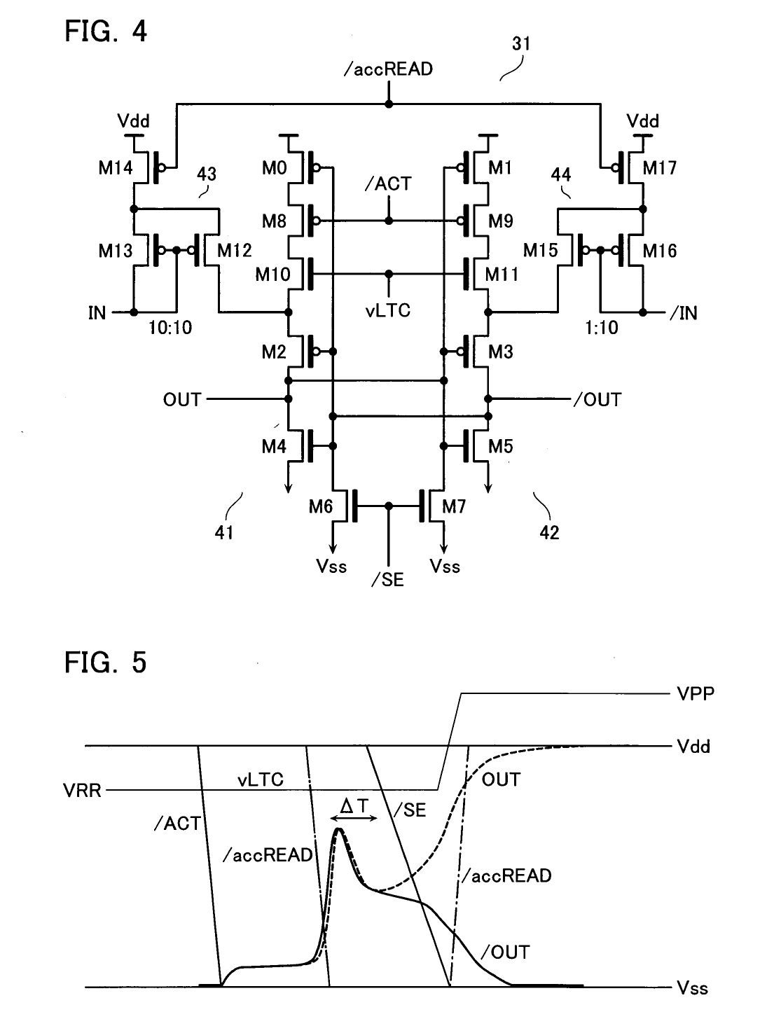

FIG. 4 shows the configuration of the sense amplifier(SA) 31, which is constructed as a current sensing type of sense amplifier for sensing small cell current such as 100 nA or less at a high rate. The basic configuration of this sense amplifier has already been proposed in JP 2005-285161A.

In the sense amplifier 31, first current path 41 and second current path 42 are disposed symmetrically. The first current path 41 contains PMOS transistors M0, M8, NMOS transistors M10, PMOS transistor M2 and NMOS transistor M4 connected in series between Vdd and Vss. Similarly, the second current path 42 contains PMOS transistors M1, M9, NMOS transistors M11, PMOS transistor M3 and NMOS transistor M5 connected in series between Vdd and Vss.

Sources of NMOS transistors M2 and M3 are coupled to input nodes IN and /IN via current mirror circuits 43 and 44, respectively. The current mirror 44 disposed on the input node /IN to be coupled to a reference bit line RBL has PMOS transistors M15 and M16, the size ratio of which is set to be 1:10. Therefore, one tenth of the reference cell's current is carried in the sense amplifier as “reference current”.

The current mirror 43 disposed on the input node IN side is a dummy circuit for securing a symmetry between the input nodes IN and /IN, and the size ratio of PMOS transistors M12 and M13 is set to be 10:10. Therefore, a selected cell's current carried in the input node IN is carried in the sense amplifier as it is.

These current mirrors 43 and 44 are coupled to the power supply node Vdd via PMOS transistors M14 and M17, respectively, driven by activation signal /accREAD.

The connection node between PMOS transistor M2 and NMOS transistor M4 in the first current path 41 serves as one output node OUT. The connection node between PMOS transistor M3 and NMOS transistor M5 in the second current path 42 serves as the other output node /OUT.

Gates of PMOS transistors M0, M2 and NMOS transistor M4 in the first current path 41 are coupled in common to one output node /OUT; and gates of PMOS transistors M1, M3 and NMOS transistor M5 in the second current path 42 to the other output node OUT. These transistors constitute a CMOS latch. That is, a CMOS inverter constituting the first current path 41 and another CMOS inverter constituting the second current path 42 constitute a latch with such an interconnection that input/output nodes thereof are cross-coupled.

PMOS transistors M8 and M9 are activating-use ones, the gates of which are driven by activation signal /ACT. NMOS transistors M10 and M11 serve as current regulating devices in the current paths 41 and 42, respectively, the gates of which are driven by signal vLTC. The sense amplifier current will be defined by these current regulating devices.

Gates of NMOS transistors M4 and M5 are coupled to Vss via NMOS transistors M6 and M7, respectively, the common gate of which is driven by sense signal /SE. That is, when /SE=“H”, these NMOS transistors M6 and M7 are turned on, so that NMOS transistors M4 and M5 in the CMOS latch are kept off.

Currents flowing in the current paths 41 and 42 in accordance with activation signal /ACT=“L” are drawn to Vss via NMOS transistors M6 and M7, respectively, until when /SE becomes “L”. When cell current and reference current are input, and then /SE becomes “L” in a data sense mode, NMOS transistors M6 and M7 are turned off to shut the current paths, and drain voltage difference thereof is subjected to positive feed-back and amplified.

The operation of the sense amplifier SA will be explained in detail with reference to FIG. 5.

While the sense signal /SE is “H”, NMOS transistors M6 and M7 are kept on, and output nodes OUT and /OUT are kept in a low level (“L”) state. When activation signal /ACT becomes “L”, current flows in the current paths 41 and 42. When cell current catching signal /accREAD becomes “L” and starting current injection for the bit line BL and reference bit line RBL coupled to the input nodes IN and /IN, a small drain voltage difference is generated between the drains of NMOS transistors M6 and M7 in accordance with the difference between a cell current and a reference current (one tenth of the reference cell current). The above-described “difference” between the cell current and the reference current will be simply referred to as a “cell current difference” hereinafter.

After a certain time ΔT while the cell current difference is influenced, sense signal /SE becomes “L”. In receipt of it, NMOS transistors M6 and M7 are turned off, whereby one of NMOS transistors M4 and M5 is turned on while the other is turned off due to the positive feed back operation of the latch circuit. That is, when NMOS transistors M6 and M7 are turned off, the timing difference based on the cell current difference is transformed to the drain voltage difference, and this is amplified.

Transistors M10 and Mil are suppressed in a low conductance state with gate signal vLTC set at low level VRR at the beginning of sensing. Therefore, the sense amplifier current supplied from the power supply node Vdd is squeezed, and the cell current difference supplied via the pair of transistors M12 and M15 will affect strongly the state of the sense amplifier. When the sense amplifier balance is broken and decided due to the cell current difference as a result of the initial sensing, gate signal vLTC is boosted to Vpp higher than Vdd from VRR. As a result, the power supply voltage is applied to the sense amplifier, the output of which fully swings to Vdd. At this time, signal /accREAD is raised to be “H”, the cell current supplied to the sense amplifier is shut off.

Variations of shrunk transistor pairs are generated due to fluctuations of the fabrication processes. Therefore, it is desirable for canceling the variations of the sense amplifier that many transistors are connected in series in the respective current paths 41 and 42 to constitute pairs as shown in FIG. 4. In detail, M0-M1 pair, M8-M9 pair and M10-M11 pair are disposed on the Vdd side of the latch.

Specifically, NMOS transistor pair of M10 and M11 serves for suppressing the variations of PMOS transistor pair of M0 and M1 and PMOS transistor pair of M8 and M9, which serve as the feed back operation of the sense amplifier. That is, as s result of that the conductance of NMOS transistors is suppressed, the drain and source voltages of PMOS transistors disposed on the power supply node are boosted, and the conductance of PMOS transistors is increased. In other words, channel conductances of the PMOS transistor and NMOS transistor function to suppress the influences of variations of the respective transistors.

Time difference ΔT, that is defined as a time length from the falling timing of signal/accREAD to the rising timing of sense start signal/SE, will be adjusted to start sensing when the input current is set in such a level that the cell current is sufficiently influenced after stopping the cell current injection by falling/accREAD.

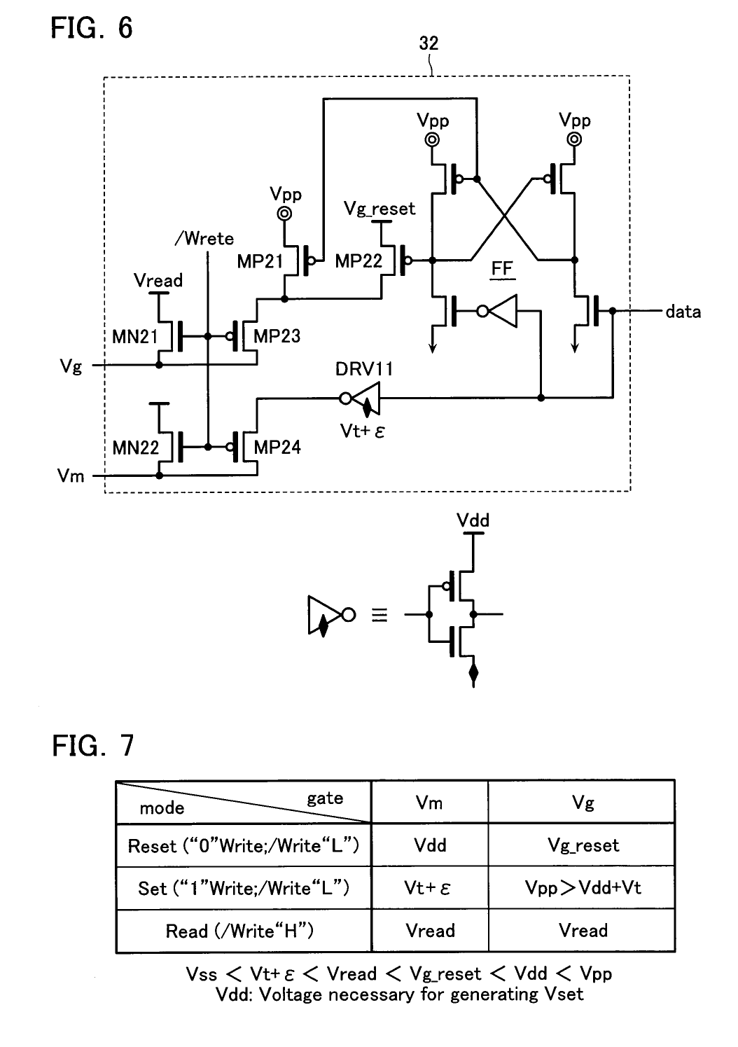

FIG. 6 shows the configuration of the write control circuit 32. The power sources supplied to this circuit are as follows: power supply voltage Vdd sufficiently high for generating cell set-use voltage Vset; boosted power supply voltage Vpp higher than Vdd; Vg_reset, Vread and Vt+ε lower than Vdd; and Vss. The relationships between these voltages are as follows:

Vss<Vt+ε<Vread<Vg_reset<Vdd<Vpp.

Input signals to be supplied to this circuit are control signal /Write and information data “data” to be written into a cell, while outputs are power supply voltage levels such as Vg and Vm. This circuit is for generating the power supply voltages in accordance with the memory operation modes and in accordance with data “data”. There is prepared PMOS flip-flop FF, the state of which is changed in accordance with data “data”. PMOS transistors MP21 and MP22 are controlled by the flip-flop FF to output the power supply voltages Vpp and Vg_reset used in the set and reset modes, respectively. These output voltages will be output to “Vg” node via PMOS transistor MP23.

Disposed on “Vm” node side are driver DRV11 for outputting Vdd and Vt+ε in the reset and set modes, respectively, and PMOS transistor MP24 for transferring the output voltage.

PMOS transistors MP23 and MP24 are driven by /Write=“L” to be turned on in a write mode (i.e., reset or set mode). In a read mode, NMOS transistors MN21 and MN22 are driven by /Write=“H” to be turned on, so that read voltage Vread is output to “Vg” node and “Vm” node.

FIG. 7 is a table for showing the levels of control signals Vm and Vg in a reset mode (“0” write mode) and a set mode (“1” write mode). Note here that a cell forming mode is basically the same as the set mode, and Vt+ε and Vpp are supplied as Vm and Vg, respectively.

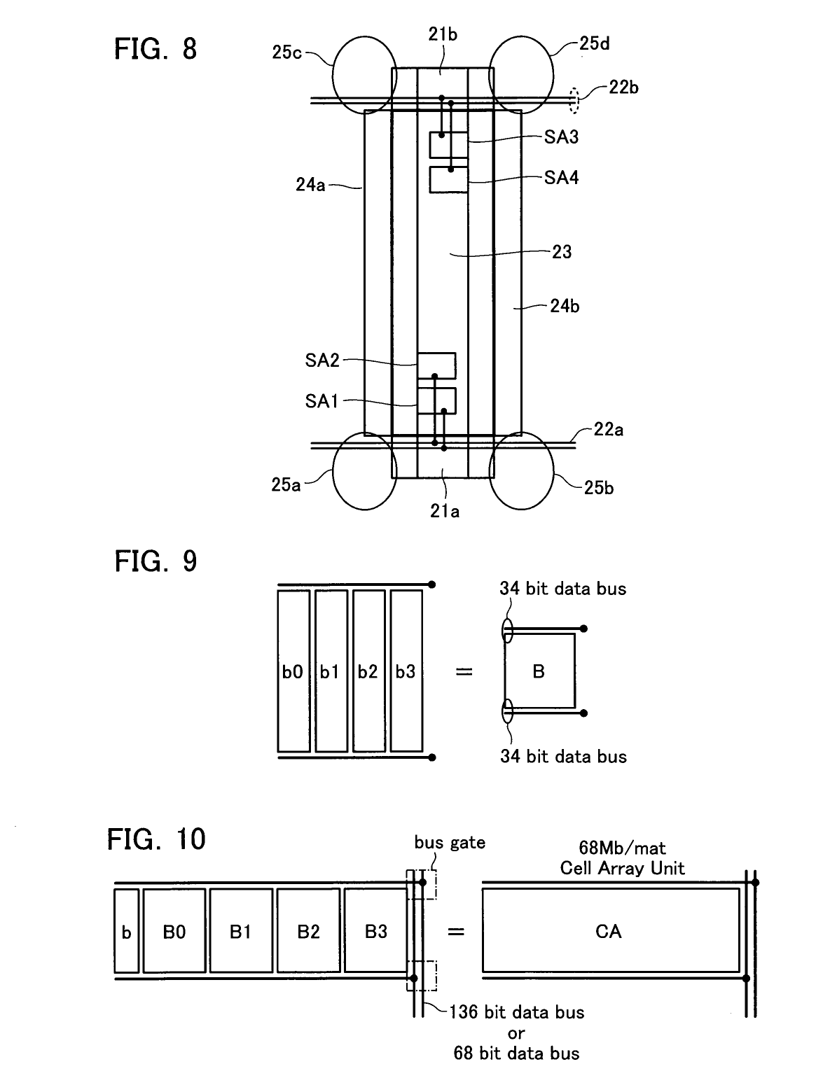

FIG. 8 shows the relationship between the sense amplifiers and data buses in the control circuit 2. Each of unit layers (i.e., mats) constituting the cell array block is 4[Mb] cell matrix formed of 4 k word lines WL and 1 k bit lines BL, which serves as a minimum cell array unit.

In the area of sense amplifier circuit 23, there are disposed four sense amplifiers SA1-SA4. Each two bit lines are coupled to these sense amplifiers via the bit line decoder/multiplexers 21a and 21b disposed on the both ends in the bit line direction. That is, when a word line WL is selected by word line driver 24a or 24b, each two bit lines are selected from the respective sides, so that four cells are accessed simultaneously.

Arranged in the buses 22a and 22b are address signal lines for selecting word lines WL and bit lines BL, data lines to be coupled to bit lines BL and the like. Disposed at the cross points between bit line decoder/multiplexers 21a, 21b and word line drivers 24a, 24b are pre-decoders 25a-25d, which serve for selectively driving the word line drivers.

The whole cell array will be constituted by two-dimensionally arranging the multiple cell array blocks 1 shown in FIG. 1. For the convenience of showing the whole cell array of the memory chip, there will be used hereinafter 16[Mb] block expression including four cell array blocks each being 4[Mb] and 68[Mb] cell array unit expression including four blocks and a quarter.

FIG. 9 shows 16[Mb] cell array block “B”, in which four 4[Mb] cell array blocks “b0-b3” are gathered. In this case, 34 bit data buses are arranged through the bit line decoder/multiplexers disposed on the both sides of the respective blocks, respectively.

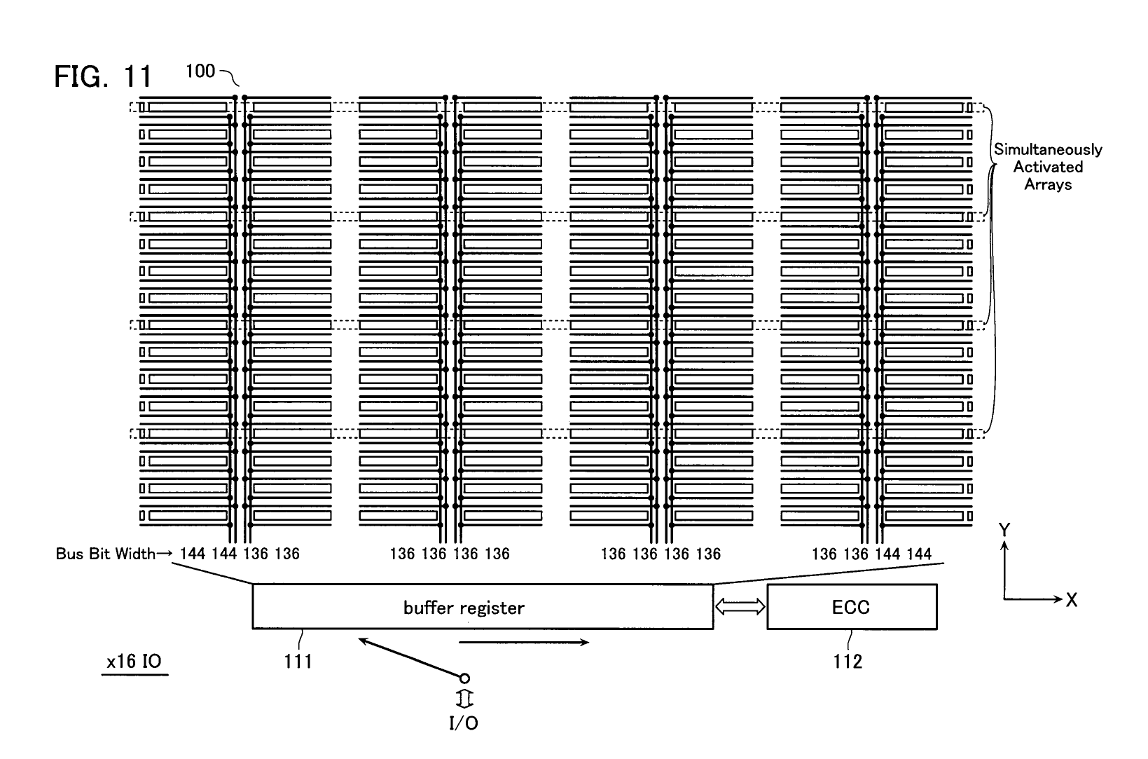

Further, as shown in FIG. 10, 68[Mb] cell array unit “CA” per mat is formed of four 16[Mb] cell array blocks “B” (B0˜B3) and one 4[Mb] cell array block “b” arranged in the data bus direction.

The cell array unit CA is formed of seventeen 4[Mb] cell array blocks “b”, each of which outputs 2-bit data from each side. Therefore, 34-bit buses are disposed on the upper and lower sides. Further Arranged on one side of the cell array unit CA is 136-bit or 68-bit data bus, to which the above described 34-bit data buses of the respective cell array blocks are selectively coupled via bus gates.

FIG. 11 shows a chip configuration of 8[Gb]+832[Mb] memory core 100 per mat in accordance with the above-described cell array unit expression. This is a ×16IOtype of example, in which 16-bit data are read and written in parallel. In this example, there is installed ECC circuit 112 correctable up to 4 bits in the memory chip.

ECC circuit 112 is a BCH-ECC system formed on Galois field GF(2ⁿ), in which there are dealt with 552 data bits (512 information data bits+40 check bits). The above-described memory capacity component 832[Mb] means check bit capacity component per mat. The details of ECC circuit 112 will be explained later.

As shown in FIG. 11, there are arranged eight-column cell array units in X direction and sixteen-row cell array units in Y direction for each mat. To adjust the read/write data bit number in relation to the ECC circuit 112, 4[Mb] cell array blocks are added to the cell array units disposed on the both ends in X direction. As a result, the capacity of one mat is 68 [Mb]×16×8+4 [Mb]×32=8[Gb]+832[Mb]. Assuming that the number of mat layers is “m”, the total capacity is 8 [Gb]×m+832 [Mb]×m.

In this example, one of the total memory mats is selected, and a quarter cell array components in a selected mat are simultaneously activated. As shown by dotted lines in FIG. 11, the simultaneously activated cell array components are selected in such a manner that these are dispersed as uniformly as possible in the memory chip.

The number of data bits read/written from/to the cell array in a lump is set at integer times as large as the number of ECC processing data bits. In detail, in this embodiment, (512[b]+40[b])×4=2208[b] data bits are read or written in a lump, which are transferred in parallel via twelve 136 bit buses and four 144 bit buses in the cell array unit. 128 bit data per 10 terminal are reciprocated between the chip and the outside, and this data transfer unit serves as “burst” hereinafter.

There is prepared a buffer register 111 for temporally store the burst data. The number of data bits in the buffer register 111 is set at M times (M is an integer) as large as the number of ECC processing data bits (including check bits). In detail, as the buffer register 111, 128+40=168 bit register is prepared for each IO terminal.

Therefore, data transfer operations are performed M times in a time-sharing mode between buffer register 111 and ECC circuit 112 to be encoded (in a write mode) or decoded (in a read mode). The code data is over-written in the buffer register 111 and transferred to the cell array or the outside.

The buffer register 111 is prepared in practice two systems as described later, which are used in an alternately interleaved manner. As a result, gapless data read or write may be performed between the chip and the external. The data transfer rate is 40[Mb/s] per IO with data cycle 25[ns], i.e., 80[Mbyte/s] for the whole memory chip.

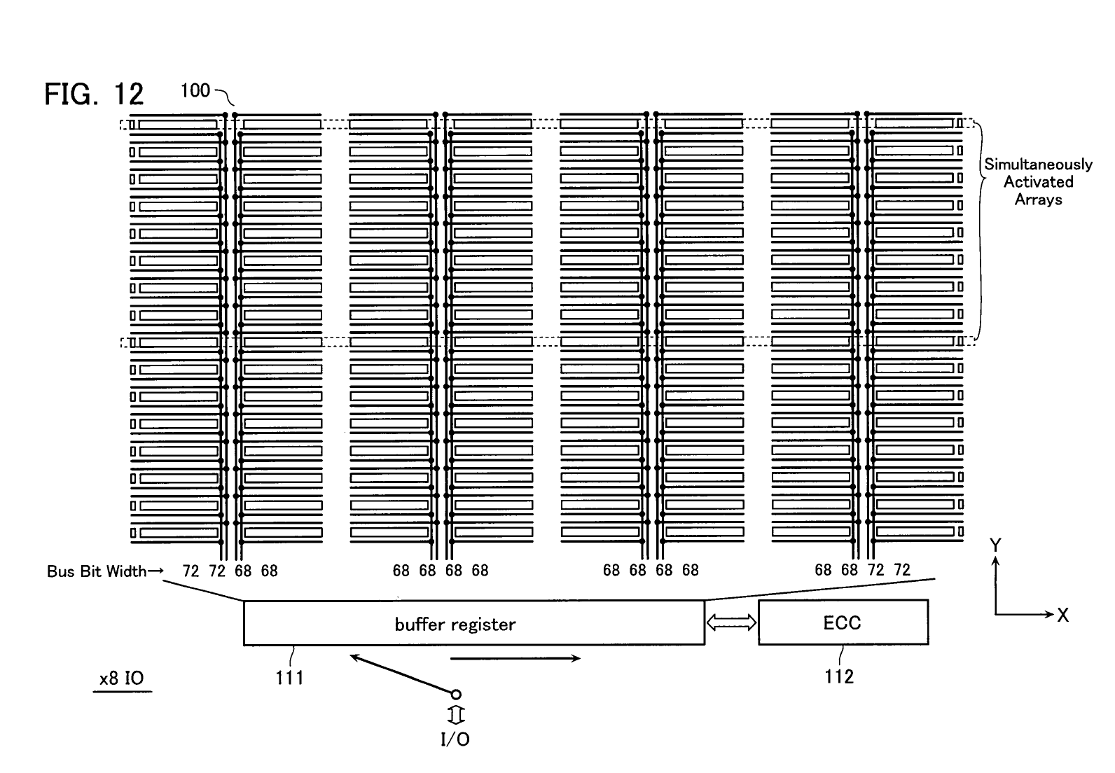

FIG. 12 shows the case of ×8IO with respect to the memory chip with the same capacity as that shown in FIG. 11. The cell array unit arrangement in the memory core 100 is the same as the example shown in FIG. 11, and the capacity is 8[Gb]+832[Mb] per mat. Assuming that the number of mat layers “m”, the total capacity is 8[Gb]×m+832 [Mb]×m.

In this example, one layer is selected in the whole memory mats, and one eighth cell array components in a selected mat are simultaneously activated as shown by dotted lines. Data bits read or written in a lump are (512[b]+40[b])×4=2208[b], which are transferred in parallel twice via 68 bit buses and 72 bit buses in the cell array unit. 128 bit data per IO terminal are reciprocated between the chip and the outside, and this data transfer unit serves as “burst” hereinafter.

To temporally store the burst data, there is prepared a buffer register 111. The number of data bits in the buffer register 111 is set at M times (M is an integer) as large as the number of ECC processing data bits (including check bits). In detail, as the buffer register 111, 128+40=168 bit register is prepared for each IO terminal.

Therefore, data transfer operations are performed M times in a time-sharing mode between buffer register 111 and ECC circuit 112 to be encoded (in a write mode) or decoded (in a read mode). The code data is over-written in the buffer register 111 and transferred to the cell array or the outside.

As similar to the above-described example, as the buffer register 111, there are prepared in practice two systems, which are used in an alternately interleaved mode. The data transfer rate is 40[Mb/s] per IO with data cycle 25[ns], i.e., 40[Mbyte/s] for the whole memory chip.

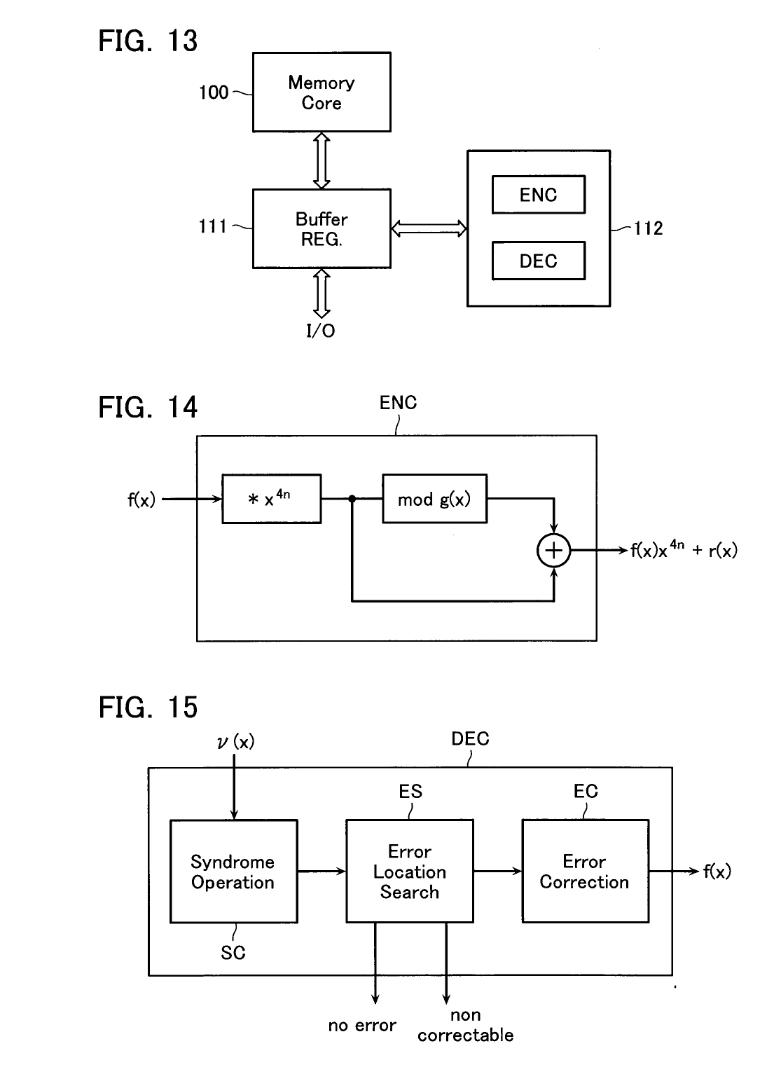

As shown in FIG. 13, disposed between the memory core 100 and ECC circuit 112 is buffer register 111, which contains two systems of registers. With these two registers, an interleave operation will be performed in such a manner that while read or write data transfer between one register and the memory core 100 (referred to as “internal transfer” hereinafter) is performed, read or write data transfer between the other register and the outside (referred to as “external transfer” hereinafter) is performed.

ECC circuit 112 is for correcting up to 4-bit errors as described above. Explaining in brief, ECC circuit 112 has encode part ENC shown in FIG. 14 and decode part DEC shown in FIG. 15.

In the encode part ENC, check bits are generated based on the information polynomial f(x), the coefficients of which correspond to data bits. That is, information bits are assigned to the coefficients a₄ₙ˜aₕ₋₁ of the information polynomial f(x) shown in the following Expression 1.

f(x)=aₕ₋₁x^{h-1-4n}+aₕ₋₂x^{h-2-4n}+ . . . +a₄ₙ₊₂x²+a₄ₙ₊₁x+a₄ₙ [Exp. 1]

With this information polynomial f(x) and four basic irreducible polynomials m₁(x), m₃(x), m₅(x) and m₇(x), code generating polynomial g(x)=m₁(x)m₃(x)m₄(x)m₇(x) is generated. Following it, polynomial f(x)x⁴ⁿ is divided by g(x), and remaining polynomial r(x) is obtained as shown in the following Expression 2.

f(x)x⁴ⁿ=q(x)g(x)+r(x)

r(x)=b₄ₙ₋₁x⁴ⁿ⁻¹+b₄ₙ₋₂x⁴ⁿ⁻²+ . . . +b₁x+b₀ [Exp. 2]

The coefficients b₄ₙ₋₁˜b₀ of the remaining polynomial r(x) serve as check bits, which constitutes data bits together with the information bits aₕ₋₁˜a₄ₙ to be written into the memory.

In detail, in this embodiment, in consideration of the error correcting rate and the like, there is achieved ECC system with BCH code (i.e., BCH-ECC system) on finite field GF(2¹⁰), in which 512 information bits and 40 check bits are used.

Read data read from the memory will be represented by the following polynomial ν(x).

$$\begin{matrix}ν ( x ) = f ( x ) {x}^{4 n} + r ( x ) + e ( x ) \\ = q ( x ) g ( x ) + e ( x )\end{matrix} \qquad [ Exp . 3 ]$$

That is, errors contained in the read data are represented by error polynomial e(x) with (h−1) degree, and this error polynomial e(x) is searched in the decode part DEC.

At a first stage, in the syndrome operation part SC, read data polynomial ν(x) is divided by the respective irreducible polynomials m₁(x), m₃(x), m₅(x) and m₇(x), and syndrome polynomials are obtained as been defined as remaining polynomials. Based on the searched syndromes, error searching part ES calculates error positions. If there are 4-bit errors at i-, j-, k- and l-degree, error polynomial is expressed as e(x)=xⁱ+x^{j}+x^{k}+x^{l}. That is, it becomes an error position search operation to search the degree number of e(x).

When error positions are not searched, the error searching part ES outputs the following signals: “no error” when there is not an error; and “not correctable” when there are five or more bit errors. Searched error bits are corrected in error correction part EC to be correct bit data.

To achieve the ECC circuit in a circuit scale as small as possible with a high speed performance, it becomes material how to make the calculation scale of the error searching part ES small. To make in practice the calculation scale small, it is effective to examine the exclusive condition of the solution searching 2-bit error, 3-bit error and 4-bit error, and to use the common circuits in the system in a time-sharing manner in accordance with the examined result. The details will be omitted here.

Next, it will be explained in detail “internal transfer”, i.e., data transfer between buffer register 111 and memory core 100.

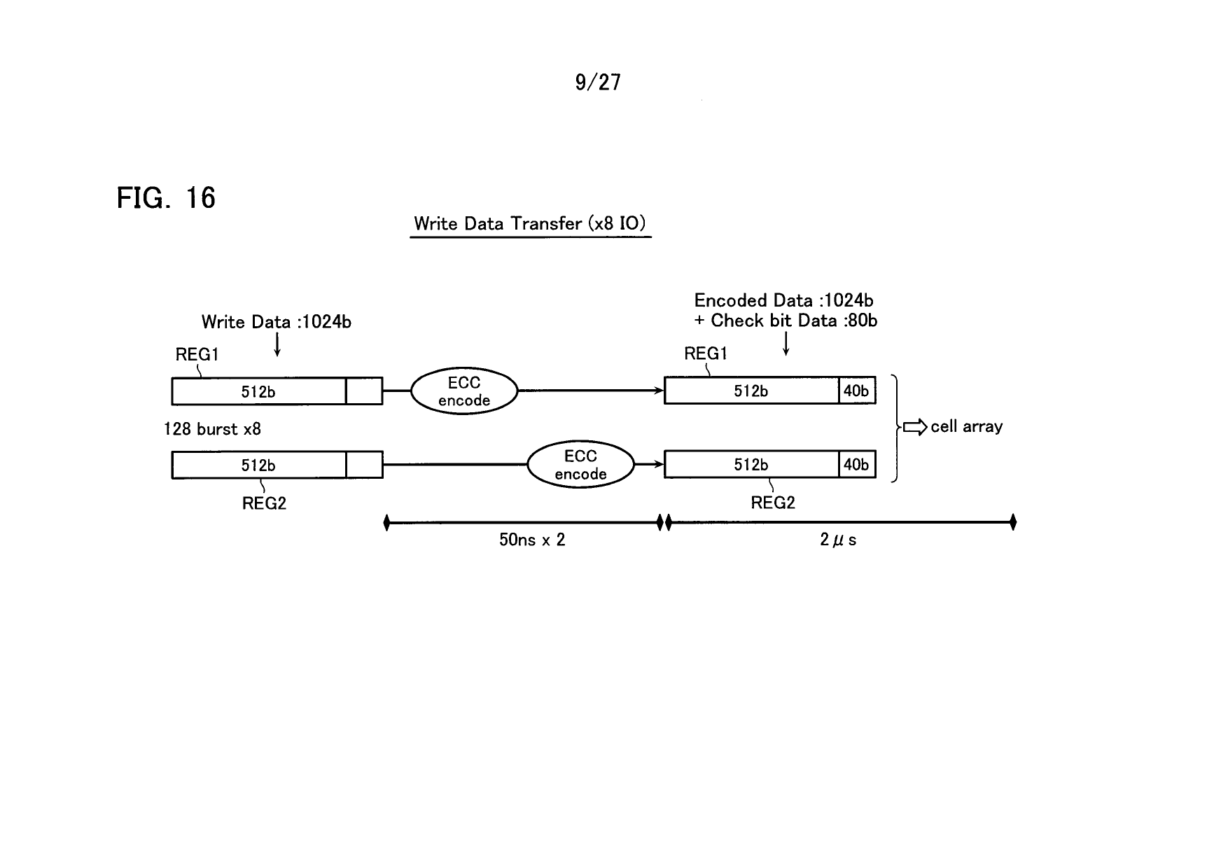

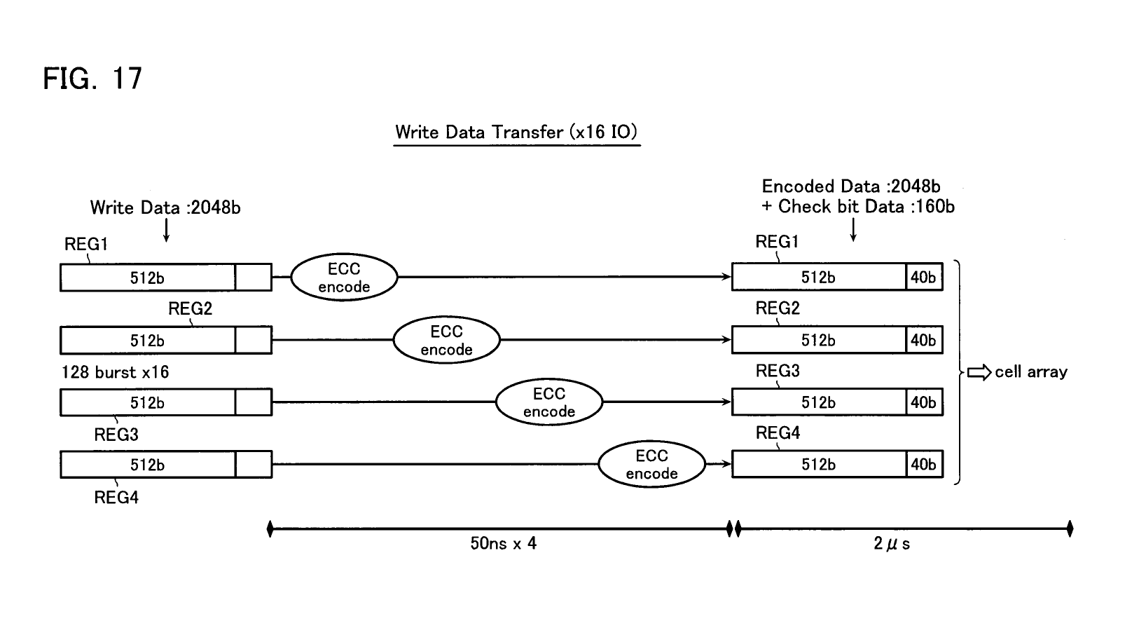

FIGS. 16 and 17 show “write data transfer” examples, in which write data are burst-transferred and loaded in the buffer registers, and then written into the memory cell array.

FIG. 16 shows a ×8IO case. In this case, burst data is 128-bit per IO, i.e., total 1024-bit write data are loaded in buffer registers. There are prepared two buffer registers REG1 and REG2, each of which is formed to be able to store 552 bits (containing information bits 512 of ECC and check bits 40). 1024-bit write data will be transferred as 128 burst data, and sequentially loaded in the registers REG1 and REG2 512-bit by 512-bit.

ECC processing is performed for every 512-bit unit. Write data loaded in registers REG1 and REG2 are transferred to the encode part ENC in ECC circuit 122 twice in a time-sharing manner, and encoded. Encoded data are over-written into registers REG1 and REG2 together with 40 check bits.

Encode time is about 50[ns], so it takes 50[ns]×2=100[ns] to encode the whole write data. It takes about 2[μs] to transfer the over-written data in the registers REG1 and REG2 and write those in the memory cell array.

FIG. 17 shows a ×16IO case. In this case also, burst data is 128-bit per IO, i.e., total 2048-bit write data are loaded in buffer registers. There are prepared four buffer registers REG1 to REG4, each of which is formed to be able to store 552 bits. 2048-bit write data will be transferred as 128 burst data, and sequentially loaded in the registers REG1 to REG4 512-bit by 512-bit.

Write data loaded in registers REG1 to REG4 are transferred to the encode part ENC in ECC circuit four times in a time-sharing manner, and encoded. Encoded data are over-written into the respective registers REG1 to REG2 together with 40 check bits.

The encoding time is about 50[ns], so it takes 50[ns]×4=200 [ns] to encode the whole write data. It takes about 2 [μs] to transfer the over-written data in the registers REG1 and REG2 and write those in the memory cell array.

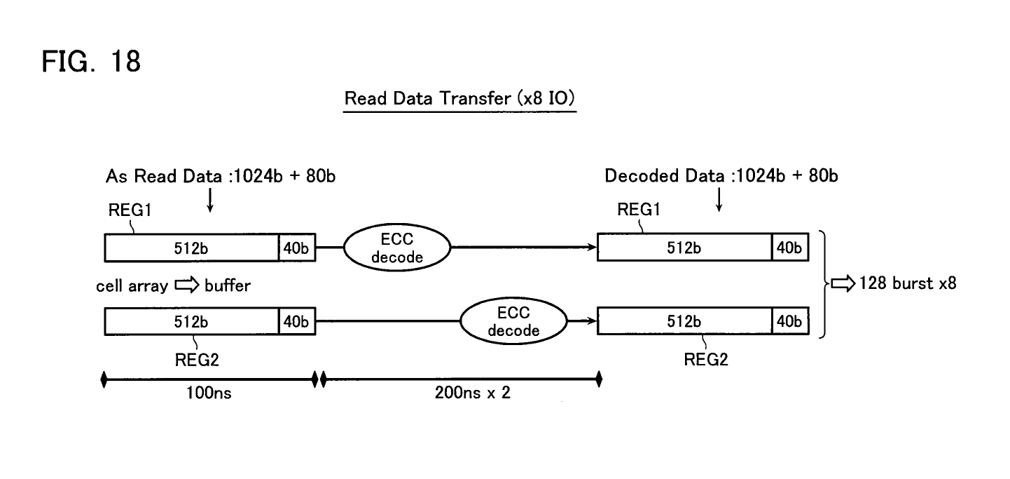

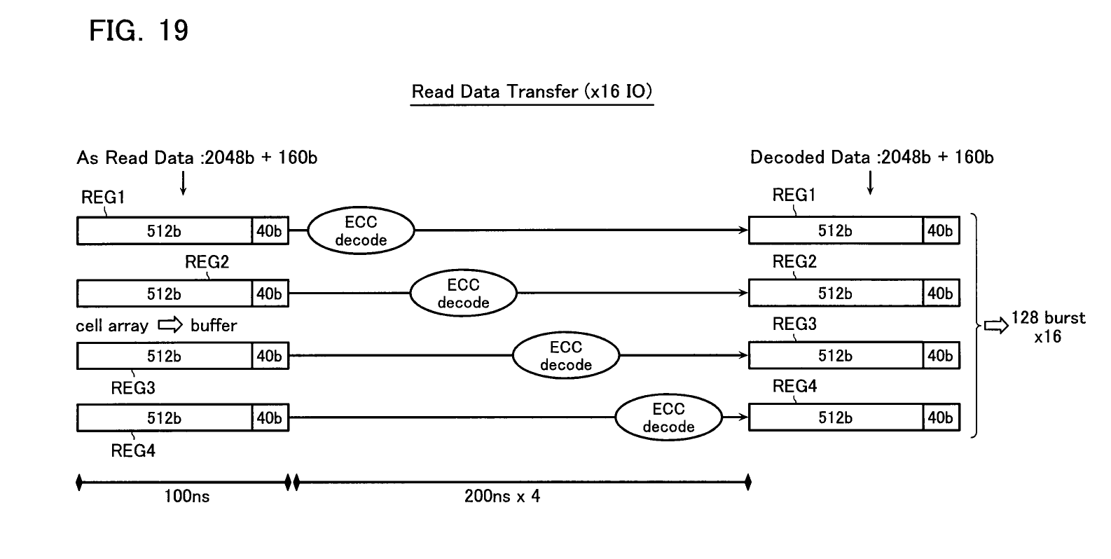

Next, with reference to FIGS. 18 and 19, it will be explained in detail “read data transfer” examples, in which cell data are read out and transferred to the buffer registers, and then burst-transferred to the outside.

FIG. 18 shows a ×8IO case. In this case, data code, (512b+40b)×2, correspond to the burst data 128 bits per IO, are read from the memory cell array and transferred to the registers REG1 and REG2. At this stage, cell data are not passed through the ECC circuit. It takes about 100[ns] to transfer this cell data.

The data code in registers REG1 and REG2 are transferred to ECC circuit in a time-sharing manner, and 128×8 data are decoded half by half. Corrected data are over-written into buffer registers REG1 and REG2.

The ECC decoding time is about 200[ns], and it takes 200[ns]×2=400[ns] to decode the whole read data. Finally, error-corrected data are stored in buffer registers REG1 and REG2 together with check bits. Corrected data in registers REG1 and REG2 are burst-transferred to the IO terminals.

FIG. 19 shows a ×16IO case. In this case, data code, (512b+40b)×4, correspond to the burst data 128 bits per IO, are read from the memory cell array and transferred to four registers REG1 to REG4. It takes 100[ns] to transfer these data. The data code in registers REG1 to REG4 are transferred to ECC circuit in a time-sharing manner, and error-corrected data are over-written into buffer registers REG1 to REG4.

The ECC decoding time is about 200[ns], and it takes 200[ns]×4=800[ns] to decode the whole read data. Finally, error-corrected data are stored in buffer registers REG1 to REG4 together with check bits. Corrected data in registers REG1 to REG4 are burst-transferred to the IO terminals.

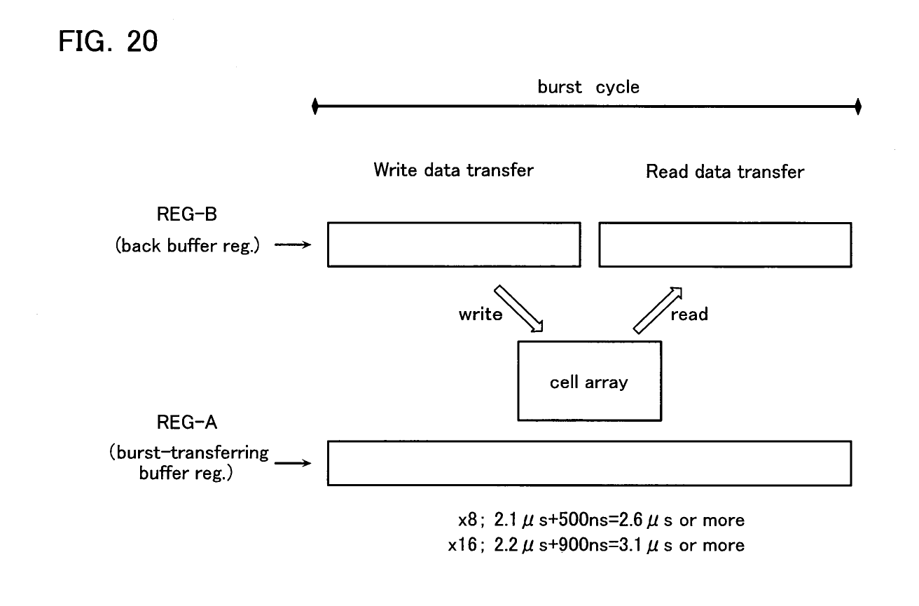

Next, with reference to FIG. 20, it will be explained an interleave transfer operation, in which “internal transfer” and “external transfer” are simultaneously performed by use of two systems of buffer registers.

It should be noted here that a buffer register used for performing clock synchronized external data transfer is previously stored with corresponding address data without regard to read/write. This is natural in a read mode. However, in this embodiment, a write mode is defined as follows: data is previously read in a write destination buffer register, and write data is over-written into this register. By use of such the write method, in case of data mask inputting, write suspending in the midst of burst transfer and the like, burst address data will be held in the register, so that data compatibility will be kept.

When one of two buffer registers is presently used for burst transfer, the operation of previously storing burst address data in a buffer register is performed for the other buffer register for preparing the following burst.

As shown in FIG. 20, assuming that burst transfer (“external data transfer”) is presently performed in one buffer register REG-A, “internal data transfer”, i.e., write data transfer (Wdt) and read data transfer (Rdt) are performed in the burst cycle in the other buffer register (i.e., back buffer register) REG-B.

Write data transfer “Wdt” is performed in one internal data transfer case, and not performed in another case. This depends on a difference in the internal data transfer sequences. Alternatively, all the cases could use such a sequence that always contains the write data transfer Wdt. This is because that data stored in the buffer register is always assured as correct data (i.e., read data is corrected through the ECC circuit; and write data is always loaded as being correct).

Data in the buffer register is write-transferred to the cell array through the encode part in the ECC circuit. Therefore, no error data code will be transferred to the cell array not only in a write mode but also in a read mode. This means that the cell array data may be refreshed. This becomes possible based on the fact that the ECC circuit is disposed halfway between the cell array and the buffer register.

In the burst cycle, data stored in REG-B is transferred to the cell array (Wdt), and then next burst address data will be transferred to REG-A from the cell array as error-corrected data (Rdt). It is in need of preparing the following burst after completing these Wdt and Rdt in the burst cycle. Assuming that read cycle time tRC and write cycle time tWC in the burst cycle is 25[ns], it is required of these data transfer operations to be completed in 25[ns]×128=3.2[μs].

As explained above with respect to times necessary for the respective data transfer operations, in case of ×8IO, it takes 2.1[μs] for Wdt, and 500[ns] for Rdt, so that the minimum total time 2.6[μs] is required. In case of ×16IO, it takes 2.2[μs] for Wdt, and 900[ns] for Rdt, so that the minimum total time 3.1[μs] is required. These minimum times are shorter than the burst cycle 3.2[μs]. Therefore, there is not generated a contradiction between the internal transfer and the external transfer.

Next, it will be explained a timing specification example of read/write data transfer in a burst cycle. In detail, a timing specification in the burst data transfer containing read burst transfer and write burst transfer and another timing specification of command signal thereof will be explained below.

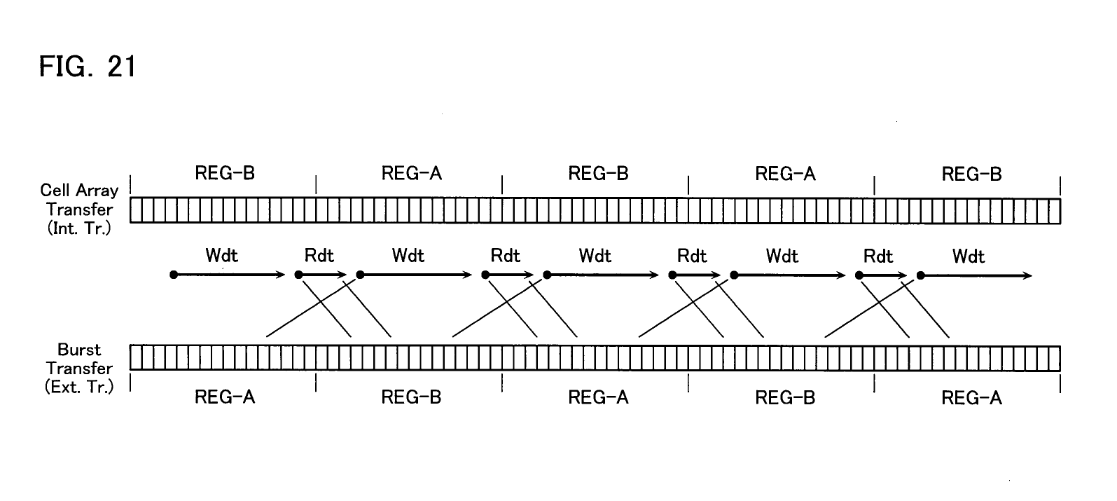

FIG. 21 shows that burst transfer operations (i.e., external transfer operations) are alternately performed with buffer registers REG-A and REG-B; and while a burst transfer operation is performed in one buffer register, cell array data transfer operations (i.e., internal transfer operations) including write burst data transfer Wdt and the following read data transfer Rdt are performed between the other buffer register and the memory cell array.

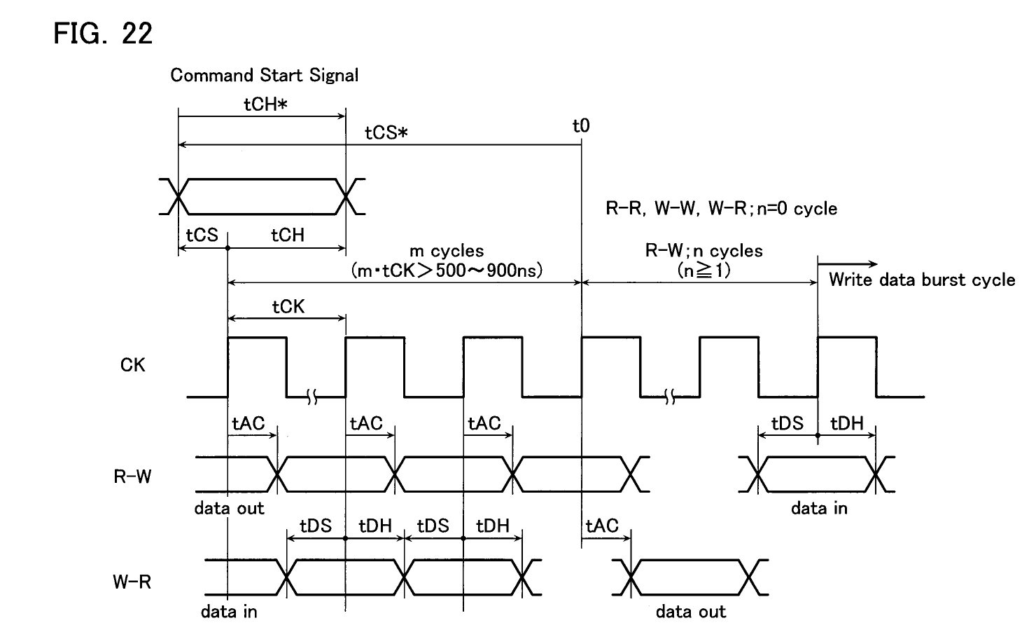

With reference to FIG. 22, it will be explained a timing specification that makes the above-described data transfer possible. Prior to starting a new burst data transfer, it is in need of deciding whether the data burst is for read data or write data. Further, it is also in need of inputting address of the burst data. Note here that the command input method with a command start signal described below has already been proposed by this inventor (for example, U.S. Pat. No. 6,185,150).

As shown in FIG. 22, command start signal is for determining a clock cycle for taking in a command, and the timing of this command start signal is defined based on the clock rising “t0” that designates a burst data switching timing. There are two methods of deciding the timing.

A first method is for defining set-up time tCS* and command-retention time tCH* of the command start signal based on a clock rising time t0. To prepare the following data burst, it is necessary to do read data transfer Rdt for the following data burst-use buffer register. It takes about 500[ns] in case of ×8IO, or about 900[ns] in case of 16×IO, to read data in a lump. Therefore, it is in need of setting the set-up time tCS* to be equal to or more than the above-described read data transfer time.

However, there will be generated a few inconveniences in this method as follows: if set-up time is too long, it becomes difficult to set it, and it also becomes difficult to set precisely a command accepting timing.

So it may be used such a second method that a timing previous to the clock edge t0 is defined by the number of clocks.

That is, it is specified m-th cycle before the clock rising edge t0 defining the data burst switching timing, and based on the m-th clock edge, the rising time (tCS) and falling time (tCH) of the command start signal is defined as shown in FIG. 22. In detail, assuming that the clock cycle time is tCK, it is required of m×tCK to be equal to or more than 500[ns] (or 900[ns]). If tCK=25[ns], then “m” is equal to or more than 20 (or 36).

In accordance with this command start signal, it is controlled to start taking in the sequential signals such as command, address and data for the following data burst cycle.

With respect to the timing clock CK and data in a read mode, data output is defined by data access time tAC defined based on the clock edge. It is also possible to give clock latency for the clock. In the example shown in FIG. 22, the clock rising edge is used as a basic timing. On the other hand, it may be used a DDR (Double Data Rate) specification, in which the both edges of the clock are used. In a write mode, it will be controlled that input data is kept during the period defined by set-up time tDS and hold time tDH.

Although it is not shown in FIG. 22 whether the data burst is write data burst or read data burst. There are four relationships in the data burst modes as follows: R-R mode, in which read data burst transfer operations are continued; W-W mode, in which write data burst transfer operations are continued; R-W mode, in which write data burst follows up read data burst; and W-R mode, in which read data burst follows up write data burst. These modes will be explained in detail below.

Mode R-R is a continuous read sequence. In this mode, there is not generated a gap between data burst cycles.

Mode W-W is a continuous write sequence. In this mode, there is not generated a gap between data burst cycles as similar to mode R-R.

Mode R-W is a sequence, in which read data burst is exchanged with write data burst. In this mode, it is in need of shifting the relationship between data and clocks when exchanging the data burst because the definition between data and the clock edge in the read data burst is different from that in the write data burst.

In detail, since, in the write data burst, data is relatively advanced to the clock edge, there is a possibility that read data burst before timing t0 is over-lapped to the following write data burst. To avoid this situation, the write burst data input needs to be delayed by n (n≧1) clock cycles after t0. That is, the write data burst is to be controlled to start after n-clock cycle lapsing.

Mode W-R is a sequence, in which write data burst is exchanged with read data burst. In this mode, the timing between data and the clock edge is shifted to be delayed. Therefore, there is not generated a contradiction in the relationship between data and the clock edge without specified considerations. That is, it is permissible to set n=0.

In the scheme, in which ECC refresh is performed for read data, write data transfer Wdt is always performed at every exchanging time of the buffer registers. By contrast, in case the ECC refresh is not performed, the write data transfer is performed only at the exchanging time after the write data burst. In case of read data transfer Rdt, the data transfer from the cell array to the buffer register starts just after the burst address is determined in accordance with command. That is, this read data transfer Rdt is performed without relation to whether the following burst is for write data or read data.

In FIG. 22, the clock cycle tCK is defined as a period from the rising time to the falling time of clock CK. In consideration of a double data rate (DDR) scheme, the clock cycle may be defined as a period between adjacent clock edges each serving as a basic timing of data, command and the like. In detail, in the DDR scheme, the clock cycle is defined by the clock edges.

In the above-described example, in case of the external data transfer, i.e., in consideration of the data read or write burst performed between the memory and the outside, 128-cycle burst is used. Therefore, there may be often generated such a situation that the burst data transfer is finished halfway. In this case, it is required to keep the compatibility between data in the memory cell array and the corresponding read/write data. A method of keeping the data compatibility will be explained below.

There are two cases where the burst data transfer ends halfway as follows: an “interrupt” case, in which the present burst cycle is finished halfway for starting a new burst cycle; and a “stop” case, in which the present data burst is finished halfway for forcedly ending the memory access.

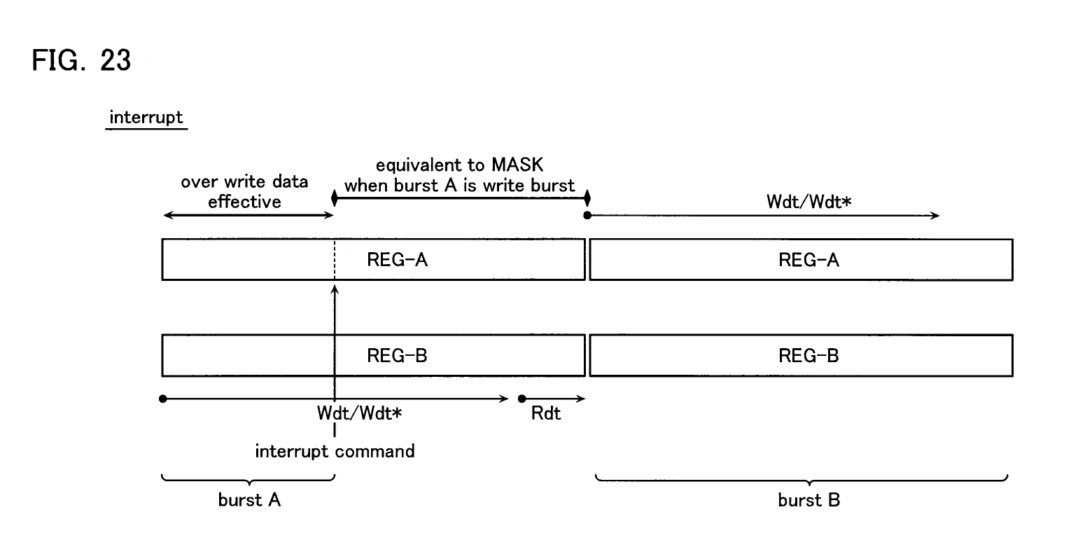

FIG. 23 shows an interrupt example for interrupting a burst cycle. Assume here that an interrupt command is input at a halfway timing in the burst clock cycle of “burst A” performed with buffer register REG-A. This command setting will be explained in detail later.

If “burst A” is write data burst, write data supplied from the external is over-written in the buffer register REG-A until when the interrupt is generated. The remaining data in the buffer register after the interrupt timing are corrected data as it is obtained by passing write destination burst data through the ECC circuit. That is, over-write is not performed on the remaining data area as similar to the “mask operation of data write” described later.

To write the over-written data in the buffer register into the memory cell array, it is in need of passing it through the ECC circuit to obtain code data (i.e., it is necessary to do write data transfer Wdt). During burst transfer in register REG-A, write data transfer Wdt or Wdt* (Wdt*; write data transfer without passing through ECC circuit), and read data transfer Rdt are performed in register REG-B.

Therefore, after the write data transfer Wdt or Wdt* in the register REG-B is finished and after read data transfer Rdt is performed for a new burst address, it becomes possible to start new burst transfer “burst B” after the interruption. Simultaneously when the new burst “burst B” starts, write data transfer Wdt or Wdt* start from the register REG-A, in which “burst A” has been interrupted as described above.

In FIG. 23, assuming that “burst A” is read burst, only the burst read is suspended, and the whole data in the register REG-A are kept as error-corrected read data. Therefore, when writing back this data to the cell array, there is no need of encoding it. That is, data and check bits in register REG-A are written back as it is. This is defined as write data transfer Wdt* without passing ECC circuit as described above.

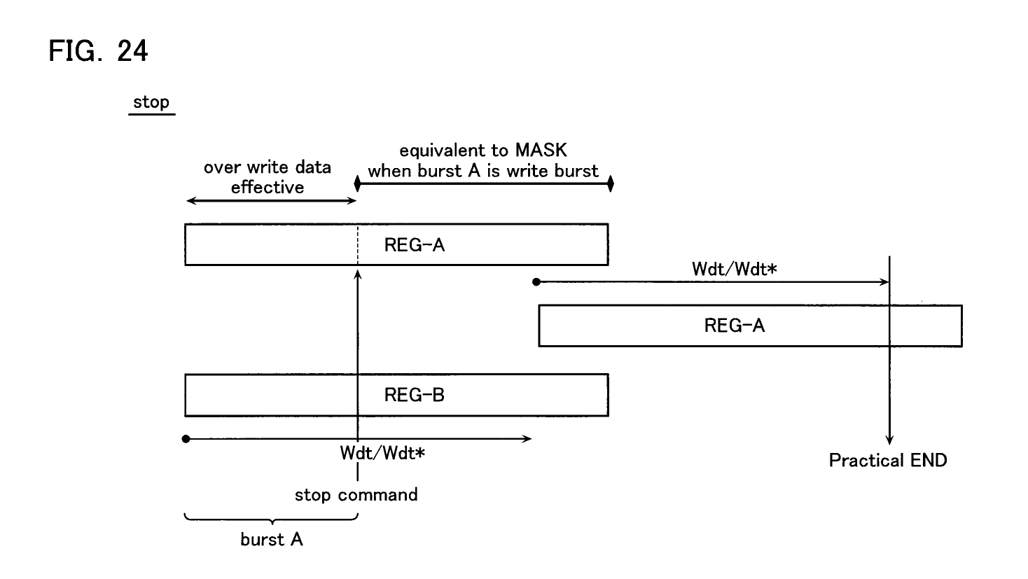

FIG. 24 shows a stop case for stopping a burst cycle halfway. Assume here that the stop command is input at a halfway timing in the burst clock cycle of “burst A” performed with buffer register REG-A.

If “burst A” is write data burst, write data supplied from the external is over-written in the buffer register REG-A until when the stop is generated. The remaining data in the buffer register after the stop timing are corrected data as it is obtained by passing write destination burst data through the ECC circuit. That is, over-write is not performed on the remaining data area as similar to the “mask operation of data write”.

To write the over-written data in the buffer register into the memory cell array, it is in need of passing it through the ECC circuit to obtain code data (i.e., it is necessary to do write data transfer Wdt).

It is after completing the write data transfer Wdt(or Wdt*) in the register REG-B that it becomes possible to start the write data transfer Wdt from register REG-A, in which “burst A” has been stopped.

In FIG. 24, assuming that “burst A” is read burst, only the burst read is suspended, and the whole data in the register REG-A are kept as error-corrected read data. Therefore, when writing back this data to the cell array, there is no need of encoding it. That is, data and check bits in register REG-A are written back as it is. This is defined as write data transfer Wdt* without passing ECC circuit as described above.

After completing the write data transfer Wdt or Wdt* from buffer register REG-A, the memory access will be ended practically.

In the interrupt case, it is after completing the data transfer preparation that it becomes possible to start a new burst cycle. This new burst cycle is decided not from the external, but in accordance with the memory system. Since there is generated a gap due to clock cycle during the data transfer between the memory and the external, it is required of the memory to output a signal designating the internal data transfer state. It may be judged to start the new burst cycle with this signal.

There is a case, in which write data is subjected to ECC processing, and another case, in which write data is not subjected to ECC processing. This relates to the ECC refresh to be described later, the summary of which will be explained here.

ECC refresh is defined as follows: to cancel accumulated errors contained in the accessed burst data, store error-corrected data in the buffer register, and transfer it to the memory cell array, thereby refreshing the data. This mode is based on the assumption that data stored in the buffer register is always correct.

That is, in case of read data burst, read data is decoded in the ECC circuit, and correct data including check bits are stored in the buffer register. In case of write data burst, correct write data are over-written into the buffer register. Note here that the over-written data need to be encoded for generating check bits.

In the burst cycle, two systems of buffer registers are used in parallel in such a manner that one register serves for performing the external data transfer while the other register serves for performing the internal data transfer between cell array data and the register. The write data transfer Wdt from the register to the cell array is divided into two cases as follows: one case where data stored in the register are used in the read burst; and the other case where data stored in the register are used in the write burst.

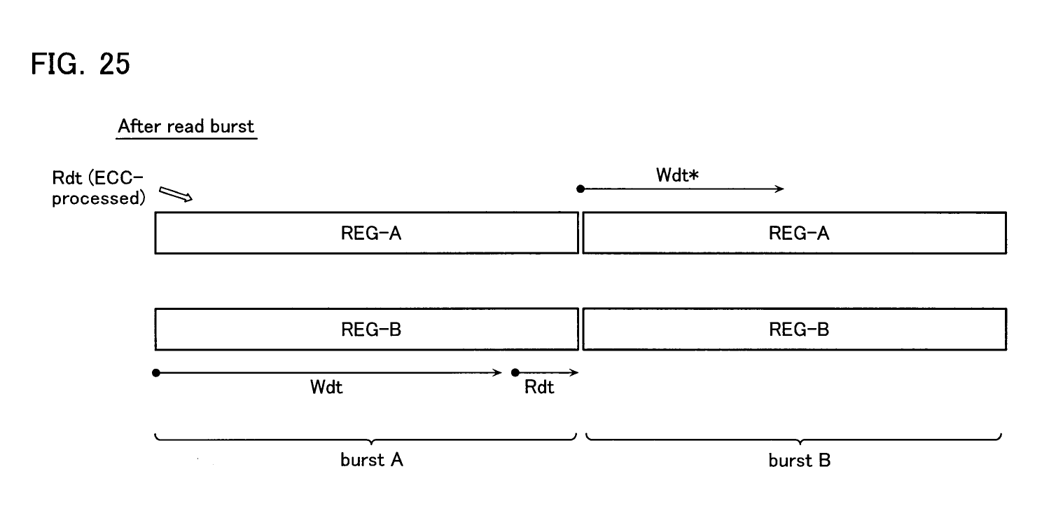

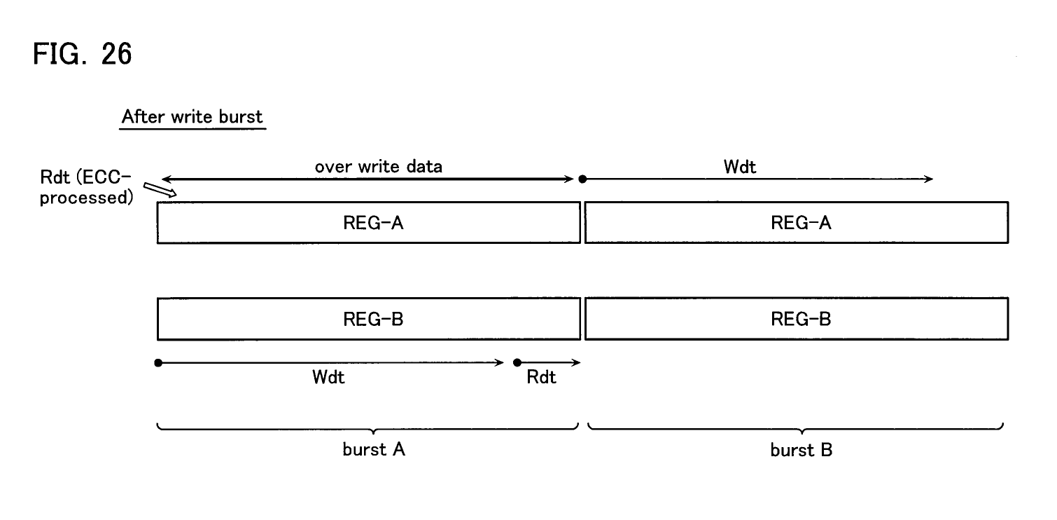

The above described two cases will be explained with reference to FIGS. 25 and 26.

FIG. 25 shows that in the buffer register REG-A, write data transfer Wdt* for the cell array is performed after read burst “burst A” at the back of write burst cycle “burst B” in the buffer register REG-B. In this case, the write data transfer at the back of “burst B” is for transferring correct data including check bits, so that this data may be written into the cell array as it is without passing them to ECC circuit. That is, this write data transfer is defined as the write data transfer Wdt* without ECC processing.

As described above, It takes about 100[ns] in case of ×8IO (or about 200[ns] in case of ×16IO) to encode data in the ECC circuit. That is, the transfer period of the write data transfer Wdt* may be made to be shorter by the encode time in comparison with the write data transfer Wdt. To avoid the complicated judgment with respect to the burst type, it is possible to perform the normal write data transfer Wdt, and then encode the data.

FIG. 26 shows that in the buffer register REG-A, write data transfer Wdt for the cell array is performed after write burst “burst A” at the back of burst cycle “burst B” in the buffer register REG-B. In this case, at least a part of data in the register REG-A written by “burst A” are over-written data, and it needs to be encoded. Therefore, the write data transfer Wdt in the burst cycle “burst B” is normal one with ECC processing.

Read burst data just after the write transfer Wdt or Wdt* is in a state that there are little errors because this data has been refreshed. Data written into the memory cell array are disturbed variously thereafter, and the number of errors will be increased. Therefore, it is desirable to perform such an “ECC refresh” operation as to read data from the cell array to the buffer register and write back it to the cell array before the number of errors is over a correctable value in the ECC circuit. The ECC refresh will be explained later.

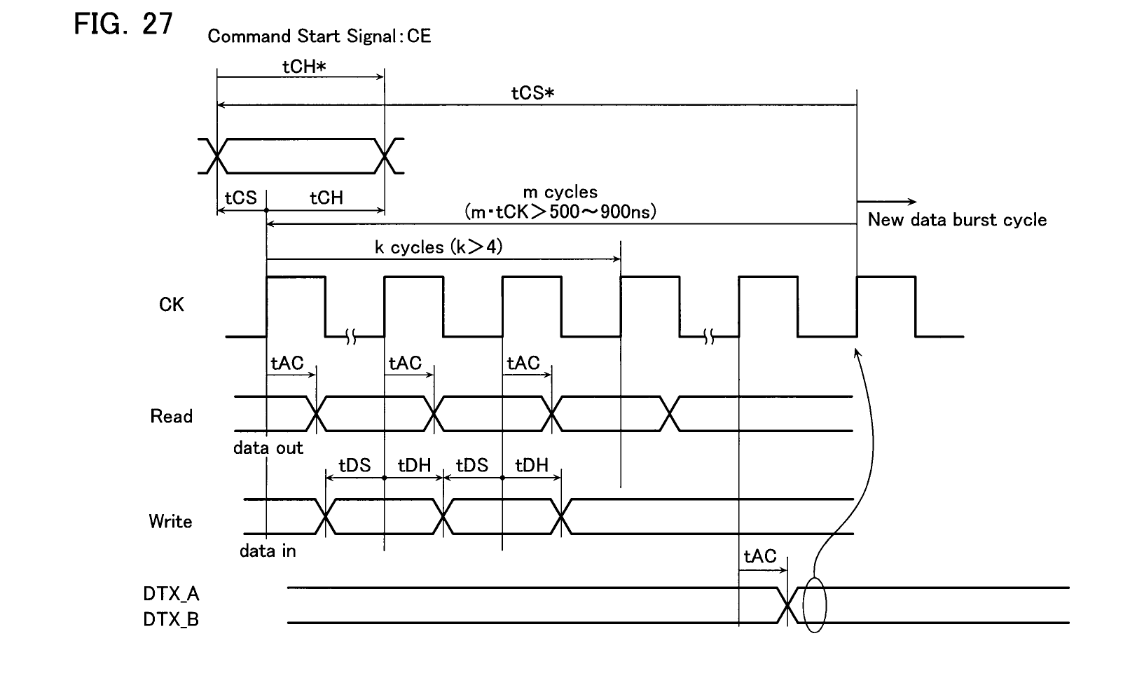

Next, with reference to FIG. 27, it will be explained a timing specification of the burst cycle interruption.

Command start signal CE (designating “command acceptable”) is defined by time tCS* or clock cycle number “m” previous to a noticed clock edge, from which a new data transfer cycle is to be started. As shown in FIG. 27, set-up time tCS and hold time tCH of the command start signal CE are defined based on the clock edge defined by the above-described time tCS* or cycle number “m”. This timing definition including cycle number “m” and the like is the same as that in the burst exchange specification described above. Such the timing definition is not necessary in case of burst “stop” because there is no need of starting a new burst cycle.

Command code may be accepted from the next clock of a clock cycle, in which the command start signal CE is accepted. With respect to the present burst data, external data transfer from the buffer register will be stopped at the next cycle of the clock cycle, in which it is judged whether the command code designates “interrupt” or “stop”. Therefore, to judge the command code, there are prepared “k” cycles after the command start signal CE setting cycle. Assuming that the command code is formed of three bits, “k” is set to be 4 or more.

As explained above, the command start signal CE setting cycle is determined based on a clock edge, from which a new data transfer cycle is to be started. However, there may be generated such a situation that the cell array data transfer presently performed simultaneously with the data burst cycle to be interrupted or stopped is not completed due to a defective CE timing.

In consideration of this, as shown in FIG. 27, signals DTX_A and DTX_B are output outside for designating the internal data transfer state between the cell array and the buffer registers.

Explaining in detail, DTX_A=“1” (=“H”) designates a period, in which the internal data transfer with buffer register REG-A is permitted while DTX_B=“1” (=“H”) designates another period, in which the internal data transfer with buffer register REG-B is permitted. The switching time of these signals is set to be synchronized with the clock CK after completion of the data transfer between the cell array and the buffer register. In detail, as shown in FIG. 27, the signals are switched at timing of tAC delayed from the clock edge as similar to the case of data output timing.

Data transfer operations with buffer registers REG-A and REG-B are alternately performed. Therefore, DTX_A and DTX_B may be unified to one signal, which designates one data transfer period when “1”, and the other data transfer period when “0”. The successive clock cycles after exchanging DTX_A, DTX_B serve as new data transfer cycles (new burst cycles).

In case a burst cycle is interrupted, a new data burst is performed and completed after DTX_A and DTX_B are switched, and then cell array data transfer operation is completed after waiting the timing when DTX_A and DTX_B are switched again, whereby data stored in the cell array and the external reciprocated data will be compatible with each other.

To examine the detail of the ECC refresh, the scheme of data transfer between the buffer register and the cell array will be summarized again here. It has already been explained above that data in the buffer register are always correct. Whether the check bit-use register portion in the buffer register corresponds to correct data or not will be dependent on the operation sequence.

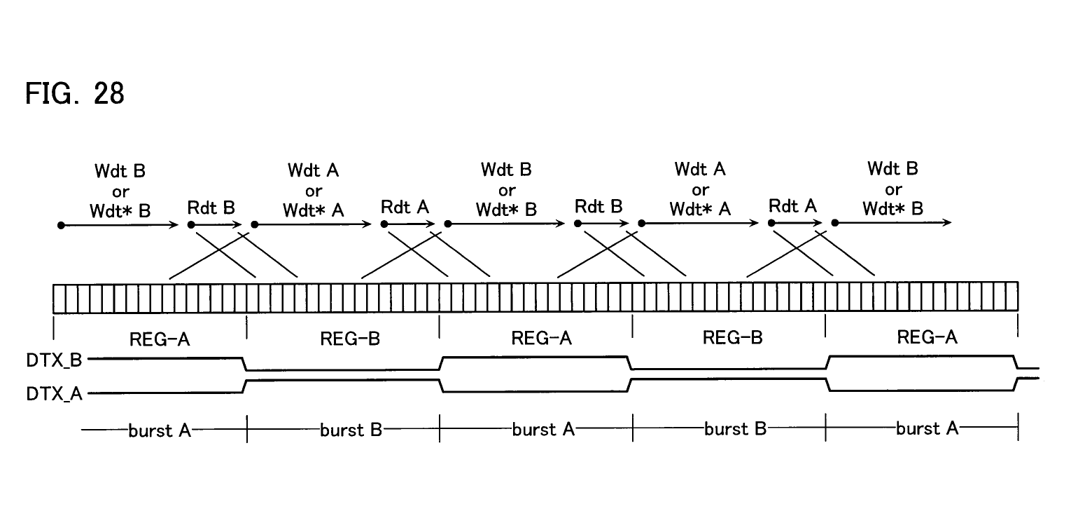

FIG. 28 shows an interleave operation of burst cycles “burst A” and “burst B” with two systems of buffer registers REG-A and REG-B. Internal data transfer states in the respective burst cycles may be monitored by the state signals DTX_A and DTX_B.

There are two kinds of write data transfer operations performed at the back of burst data transfers, as follows: write data transfer “Wdt”, in which write data in a buffer register are encoded in the ECC circuit, and the encoded data stored in the buffer register are transferred to and written into the cell array; and write data transfer “Wdt*”, in which write data are written into the cell array without passing through the encode part. On the other hand, in case of read data transfer “Rdt”, read data read from the cell array are error-corrected through the ECC circuit and stored in a buffer register as code data, which are burst-transferred to the external.

Which of Wdt and Wdt* is used will be judged in accordance with the history whether the previous burst cycle is a read cycle or a write cycle.

As shown in FIG. 28, while burst transfer “burst A” is performed in the register REG-A, internal transfer (WdtB or Wdt*B, and RdtB) may be performed in the back register REG-B. Similarly, while burst transfer “burst B” is performed in the register REG-B, internal transfer (WdtA or Wdt*A, and RdtA) may be performed in the back register REG-A.

Assuming that the ECC circuit is real time one, cell refresh may be performed with the above-described internal data transfer operations, in which disturbed cell's errors are corrected. In case of read data transfer (Rdt) from the cell array to a buffer register, the read data are ECC decoded. Therefore, with respect to the accessed burst address, data in the buffer register will be subjected to write-back transfer (i.e., Wdt or Wdt*). In detail, if after write burst, write data transfer Wdt with passing through ECC is selected while if after read burst, write data transfer Wdt* without passing through ECC is selected.

With respect to the remaining burst addresses in the selected cell array block, waiting cells in the mats in the selected cell array block are electrically or thermally disturbed due to repeated write transfer or read transfer operations. So, cyclically exchange the burst address in the selected cell array block every when the number of burst cycle accesses of the cell array block reach a certain value; then generate refresh burst addresses; and perform refresh operations (each including read data transfer (Rdt) and write data transfer (Wdt*)) at the respective refresh burst addresses.

To generate the above-described refresh burst address, there will be used the following two methods: an auto ECC refresh scheme; and a command ECC refresh scheme. In the auto ECC refresh scheme, there is prepared an internal burst access counter. By use of this counter, there are cyclically generated refresh burst addresses, with which refresh burst cycles are automatically repeated. By contrast, in the command ECC refresh scheme, an external memory controller monitors the burst access situation so as to issue command and address for every refresh burst address.

The auto ECC refresh scheme may be achieved by installing a control portion used in the command ECC refresh scheme in the memory chip. In this case, a status signal will be output for designating that a burst cycle is a refresh burst cycle. The command ECC refresh scheme may be adapted flexibly in accordance with the cell's disturb-proof. Only the command ECC refresh scheme will be explained below.

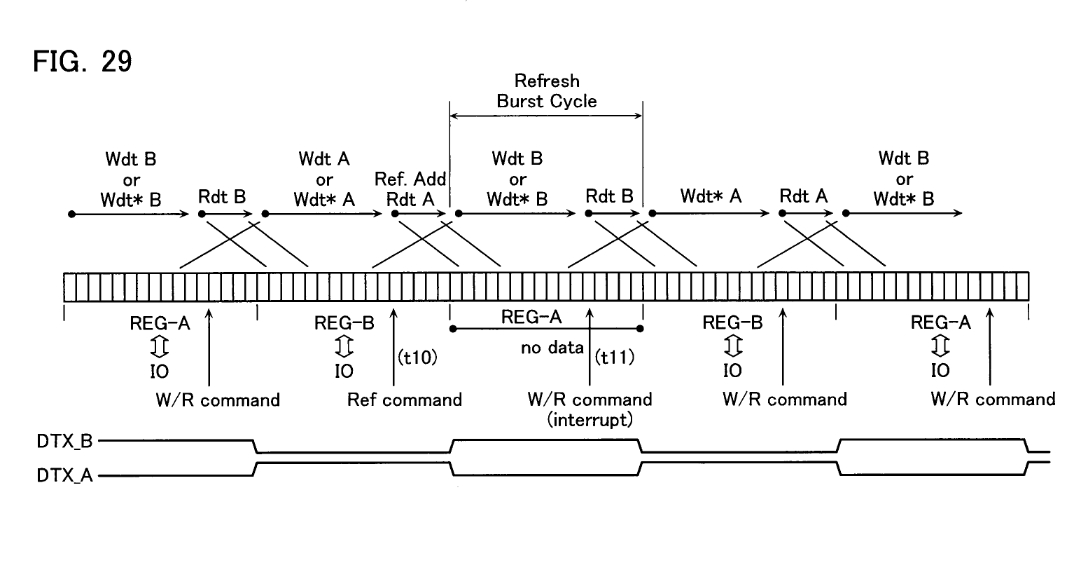

FIG. 29 shows an example, in which a certain burst cycle in the register REG-A in the burst sequence shown in FIG. 28 is set as a “refresh burst cycle”. That is, when a predetermined refresh condition is satisfied with respect to a certain cell array block in the burst sequence, external memory controller supplies a refresh burst address together with a refresh command for refreshing the cell array block.

In detail, as shown in FIG. 29, refresh command “Ref command” and refresh address “Ref. Add.” are input at a certain timing t10, so that read data transfer “RdtA” is performed for the buffer register REG-A. After this read data transfer RdtA, error-corrected data and check bits will be held in the register REG-A. In the following burst cycle, write data transfer Wdt*A, i.e., write back transfer, is performed for the refresh address, and the refresh burst cycle ends. In the refresh burst cycle, next W/R command is issued at timing t11 for the following burst cycle to restart the burst accessing.

In this embodiment, a burst cycle is formed of 128 clock cycles. Assuming that one clock cycle is 25[ns], it takes 3.2 [μs] to perform the ECC refresh cycle, in which data is not reciprocated via IO. Therefore, to restart the access, there is no need of waiting 128 clock cycles.

So, for example, use “interrupt command”, with which it is able to start the following burst cycle just after the internal data transfer, and it becomes possible to make the gap between the refresh data transfer and the following burst data transfer as small as possible. To designate this fact, it is shown parenthesized “interrupt” under “W/R command” in FIG. 29, i.e., it is desirable to use “interrupt command” as the W/R command.

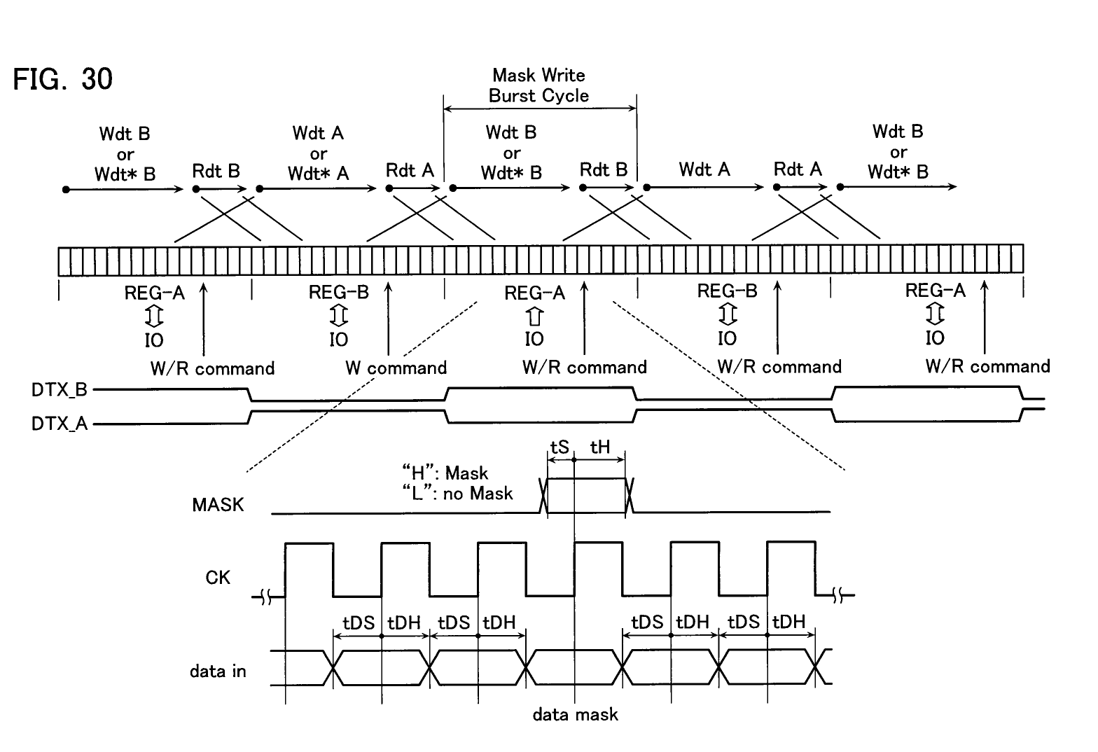

FIG. 30 shows an example, in which a “mask write” mode is set in a burst cycle in the burst sequence shown in FIG. 28. Here, a certain burst cycle with register REG-A is set as a mask write burst cycle.

A write burst sequence often needs to rewrite partial data only. It is this mask write to meet this requirement. In the write burst sequence, data of write destination burst address are ECC-corrected and transferred, i.e., read data transfer Rdt is performed. So, to prevent the register from being over-written with the external write data, mask data writing in a write burst cycle, the data of which need not be rewritten. For this purpose, it is in need of generating mask signal “MASK” for designating the clock cycle to be masked.

In FIG. 30, it is shown a timing specification example of the mask signal MASK. Setting the mask signal correspondingly to a write cycle for the corresponding buffer register, data is not transferred to the buffer register at this write cycle. That is, at the clock edge, at which MASK is “H”, data-taking becomes invalid, so that data is not over written.

Set-up time “tS” and hold time “tH” of the mask signal is defined based on the same clock edge as that of data.

The internal write data transfer in the write burst cycle followed the above-described mask write burst cycle is Wdt (i.e., write data transfer through the ECC circuit), and code data are generated again to be transferred.

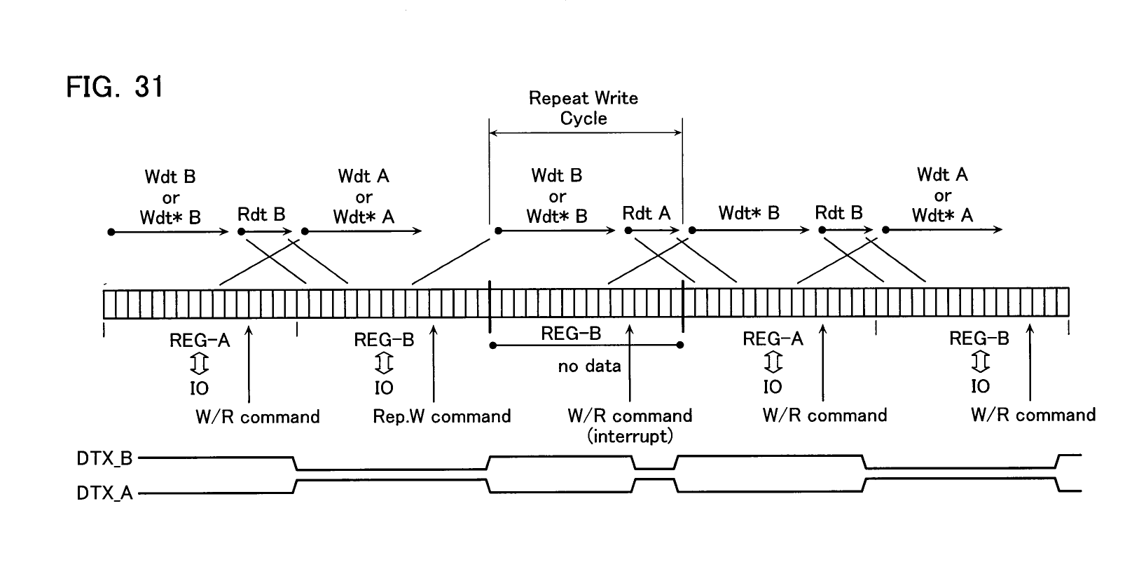

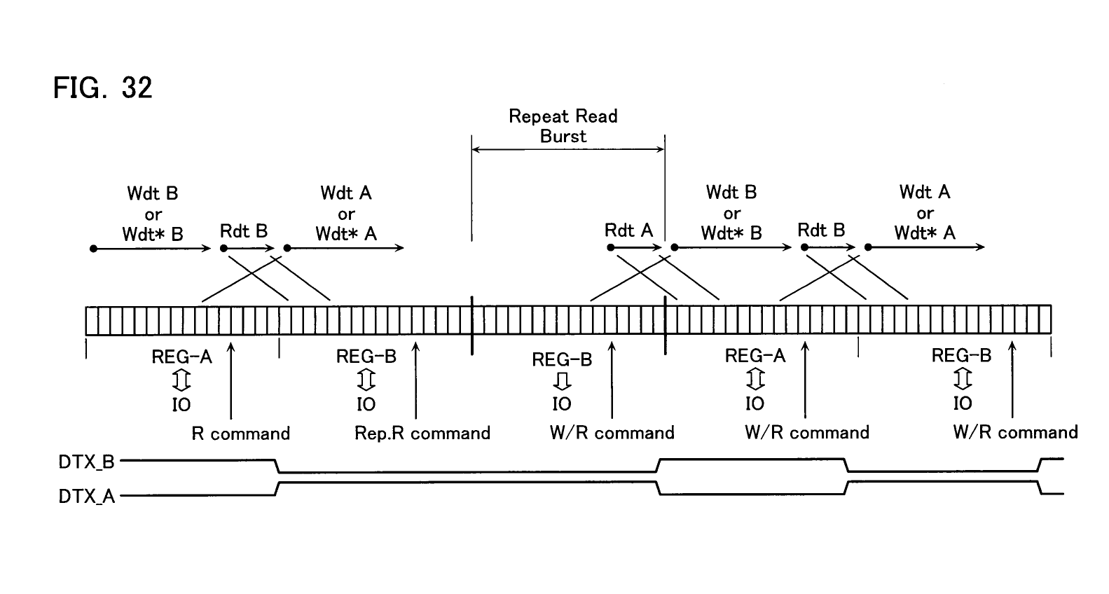

FIG. 31 shows an example of a “repeat write” transfer specification, in which the same data as in the previous burst cycle are written into the same address as in the previous burst cycle. To improve the data retention property of a resistance change memory cell without ECC system, it is in need of surely setting a low resistance state and a high resistance state. In a cell array, there are often generated such marginal cells that if not persistently writing a resistance value, sufficient data retention is not obtained.

Therefore, it is required of this cell array to be subjected to the “repeat write” transfer specification, in which the same data are successively written into a burst address plural times. That is, it is in need of preparing a command specification for repeating the write data transfer Wdt operations for writing the same data in a cell plural times.

In the repeat write cycle and the following cycle shown in FIG. 31, the exchanging of the internal data transfer buffer registers is different from the normal one. That is, in the repeat write cycle, if the repeated burst cycle is a read burst cycle, the write data transfer is Wdt* while the repeated burst cycle is a write burst cycle with register REG-B, the write data transfer is Wdt with register REG-B. In the new burst cycle, read data transfer Rdt is performed for buffer register REG-A.

After Wdt or Wdt* in the repeat write burst cycle, data containing check bits stored in the buffer register REG-B are encoded in the ECC circuit. Therefore, the internal write data transfer in the following burst cycle is Wdt*, with which cell data are over-written.

That is, data including check bits transferred in the buffer register are ECC-encoded by Rd or Wdt to be correct code data, which are repeatedly transferred to and over-written into the cell array with repeat write command “Rep. W command”.

With this repeat write, it becomes possible to reduce the number of bad data cells to be less than a predetermined permissible value.

In the burst cycle followed that, to which the repeat write command is set, there is not generated buffer register exchanging, so that the external data reciprocation is not performed. Further, this burst cycle need not 128 cycles, and it becomes possible to go to the next cycle just after the internal data transfer. Therefore, by use of “interrupt command”, it becomes possible to start the following burst cycle just after the internal transfer completion. To designate this fact, it is shown parenthesized “interrupt” under “W/R command” in FIG. 31, i.e., it is desirable to use “interrupt command” as the W/R command.

In the repeat write cycle, the internal data transfer is different from the normal one, and write data transfer and read data transfer are performed in different buffer registers. Therefore, signals DTX_A and DTX_B are changed as shown in FIG. 31.

FIG. 32 shows an example of a “repeat read” burst cycle specification, in which burst read operations are repeatedly performed for the same buffer register as in the previous burst cycle. That is a command specification for successively burst-accessing a buffer register plural times, which is set with repeat read command “Rep. R command” as shown in FIG. 32.

If the repeat read burst is one after write burst cycle, data stored in a buffer register will be read out soon from this buffer register. What is different from the repeat write shown in FIG. 31 is that the internal data transfer operation is not repeated. This is because that the same buffer register, i.e., register REG-B in the example shown in FIG. 32, serves simultaneously for the external data transfer and the internal data transfer.

Note here that it is not impossible to simultaneously transfer data from the same buffer register. Therefore, it becomes possible to constitute such a specification that the external data transfer is added to the repeat write specification.

In case the internal data transfer is not performed in the repeat burst cycle, the internal data transfer in the following burst cycle becomes Wdt* or Wdt in accordance with whether the repeated burst cycle performed with the buffer register is a read burst cycle or a write burst cycle. That is, in case of the read burst, write data transfer Wdt* without ECC-encoding may be used because correct data containing check bits are stored in the buffer register. By contrast, in case of the write burst, write data transfer Wdt with ECC-encoding will be used because it needs to generate new check bits.

The repeat cycle brings data burst outputting, and needs to use 128 cycles fully. Therefore, if there is not a special need, “interrupt” is not used.

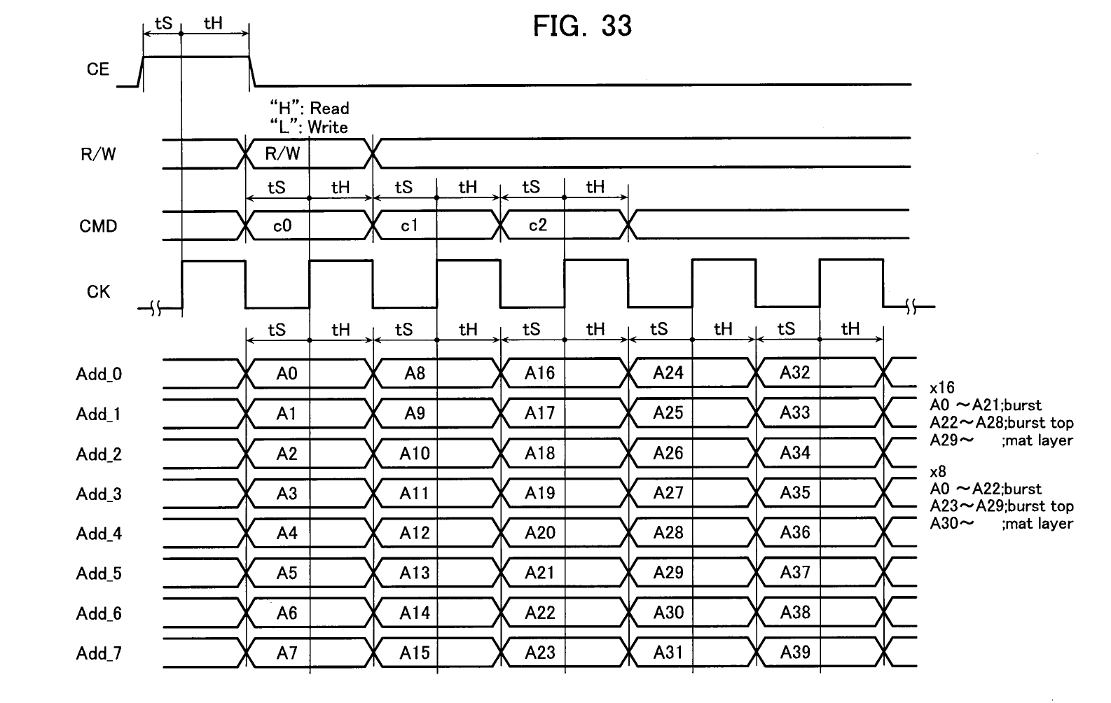

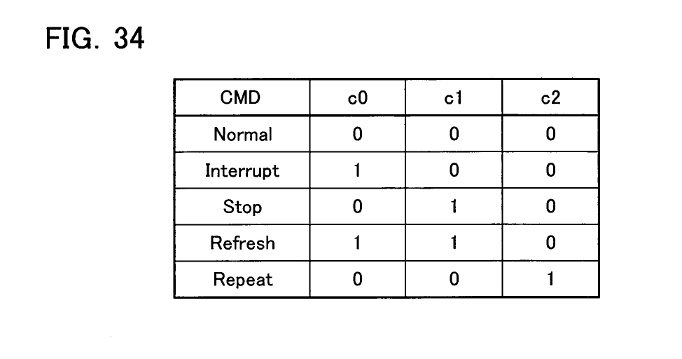

FIGS. 33 and 34 show summarized relationships between commands, burst address taking-in timings and input signals. Note here that there is JP-A 10-337114 (U.S. Pat. No. 6,185,150B1) relating to the command start signal CE. In the examples explained here, it is shown such a scheme that only one clock edge is used as the base. The explanation is omitted here that not only the rising edge but also the falling edge are used, or complementary clocks with reverse phases are used such as DDR because it will be easily understood by those skilled in the art.

A cycle following up a clock cycle with the command start signal CE=“H” serves as an input cycle for inputting command and address. Since the timing definitions of CE have already been explained above, there are shown here only “tS” and “tH” definitions for the clock edge. All input signals for the clock edge are defined by the same timing definitions as shown here. The receiver of CE is active for every clock cycle, and made to be inactive during a certain period when detecting CE=″H″. The remaining receivers become active during the certain period.

signal R/W designates whether the following new burst cycle is read(R) or write(W). Command signal CMD is a code signal of 3-bit/3-cycle. As shown in FIG. 34, operation modes “normal”, “interrupt”, “stop”, “refresh” and “repeat” are represented by the bit information c0, c1 and c2. The respective operation modes have already been explained.

Signals Add_0˜Add_7 are address bits for defining burst addresses, start addresses of burst cycles, cell array layers and the like, which are formed of 40-bit/5-cycle. The respective bit positions and cycles are shown in the signal waveforms shown in FIG. 33, and the relationships between the address bits and the operation modes are shown on the right side of the waveforms.

A burst address includes cell array block addresses. Address information of mat layers may be added to the burst address. However, mat layers may be easily changed in accordance with the fabricating processes, and bit number thereof is changed. Therefore, there are independently set the address bits corresponding to the mat layers.

Signals relating to the memory control, i.e., signals to be input to the chip pins excepting the power supply are as follows:

CK: basic clock for synchronously controlling the memory. It will be considered in a DDR scheme that complementary clock CKB is used together with CK, or strobe signal DQS of input/output data is used.

CE: command start signal for activating only one receiver, and activating command and address receivers and decoder in this state. This signal functions to prevent the signal receivers and decoders from being activated every cycle to consume the power.

R/W: selection signal for selecting a data transfer mode, read(R) mode or write(W) mode.

Add_0˜Add_7: signals for time-dividing address bits A0_˜A_39.

IO0˜IO8(or IO0˜IO16): Data input and output.

DTX_A, DTX_B: internal status signals for noticing the data transferring states in the two systems of buffer registers in the chip to the external.

As described above, according to this embodiment, it becomes possible to provide a file memory with a large capacity, in which the data reliability is secured by ECC, and a high speed data transfer operation is performed.

This invention is not limited to the above-described embodiment. It will be understood by those skilled in the art that various changes in form and detail may be made without departing from the spirit, scope, and teaching of the invention.

What is claimed is:

1. A memory device comprising:
a memory cell array;
an error-detecting and correcting circuit configured to detect and correct errors contained in read data read from the memory cell array; and
a buffer register disposed for temporally storing write data to be written into the memory cell array and read data read from the memory cell array, wherein
write data loaded in the buffer register are encoded in the error-detecting and correcting circuit to be over-written in the buffer register together with check bits, and then transferred to and written into the memory cell array, and
read data read from the memory cell array and held in the buffer register together with check bits are decoded in the error-detecting and correcting circuit to be corrected, over-written in the buffer register and then output to the external.

2. The memory device according to claim 1, wherein
the number of data bits in the buffer register is set to be integer times data bits containing check bits used in the error-detecting and correcting circuit.

3. The memory device according to claim 1, wherein
data transferring of the write data to the buffer register from the external and data transferring of the read data to the external from the buffer register are subjected to a clock-synchronized burst transfer mode.

4. The memory device according to claim 1, wherein
previously to the write data loading in the buffer register, read data of the destination address of the write data is stored in the buffer register.

5. The memory device according to claim 1, wherein
there are prepared two systems of the buffer registers, which serve alternately for burst-transferring read or write data, and wherein
within a burst cycle in one of the buffer registers, an internal data transfer mode including write data transfer and read data transfer is performed between the other buffer register and the memory cell array.

6. The memory device according to claim 5, wherein
the write data transfer in the internal data transfer mode including: encoding the write data stored in the other buffer register in the error-detecting and correcting circuit; over-writing the encoded write data in the other buffer register; and transferring and writing it into the memory cell array.

7. The memory device according to claim 5, wherein
the read data transfer in the internal data transfer mode including: reading data from the memory cell array into the other buffer register; decoding the read data in the error-detecting and correcting circuit; and over-writing the decoded read data into the other buffer register.

8. The memory device according to claim 1, wherein
the memory device has a refresh mode, in which read data containing check bits stored in the buffer register are transferred to be rewritten into the memory cell array, the read data being decoded in the error-detecting and correcting circuit to be error-corrected.

9. A memory device comprising:
a memory cell array;
an error-detecting and correcting circuit configured to detect and correct errors contained in read data read from the memory cell array; and
two systems of buffer registers disposed for temporally storing write or read data, wherein
the memory device has an external data transfer mode, in which read or write data are alternately burst-transferred with the two systems of the buffer registers, and wherein
within a burst cycle in one of the buffer registers, an internal data transfer mode including write data transfer and read data transfer is performed between the other buffer register and the memory cell array.

10. The memory device according to claim 9, wherein
the data transferring in the external data transfer mode is subjected to a clock-synchronized burst transfer mode.

11. The memory device according to claim 9, wherein
the number of data bits of each of the buffer registers is set to be integer times data bits containing check bits used in the error-detecting and correcting circuit.

12. The memory device according to claim 9, wherein
the external data transfer mode is a read sequence, in which read data are continuously burst-transferred.

13. The memory device according to claim 9, wherein
the external data transfer mode is a write sequence, in which write data are continuously burst-transferred.

14. The memory device according to claim 9, wherein
the external data transfer mode includes such a burst sequence that write data burst follows up read data burst.

15. The memory device according to claim 9, wherein
the external data transfer mode includes such a burst sequence that read data burst follows up write data burst.

16. The memory device according to claim 9, wherein
the write data transfer in the internal data transfer mode including: encoding the write data stored in the other buffer register in the error-detecting and correcting circuit; over-writing the encoded write data into the other buffer register; and transferring it to be written into the memory cell array.

17. The memory device according to claim 9, wherein
the read data transfer in the internal data transfer mode including: reading data from the memory cell array into the other buffer register; decoding the read data in the error-detecting and correcting circuit; and over-writing the decoded read data into the other buffer register.

18. The memory device according to claim 9, wherein
the memory device has a refresh mode set in the burst sequence with the buffer registers, in which read data containing check bits in the buffer registers are transferred to be rewritten into the memory cell array, the read data being decoded in the error-detecting and correcting circuit to be error-corrected.

19. The memory device according to claim 9, wherein
the memory device has a mask write mode set in the burst sequence with the buffer registers, the mask mode being defined as to mask data writing into the buffer resisters, data of which need not be rewritten.

20. The memory device according to claim 9, wherein
in the external data transfer mode, there are output status signals for designating the internal data transfer states between the memory cell array and the two systems of the buffer registers, respectively.
